(19) United States
(12) Patent Application Publication
(10) Pub. No.: US 2003/0008046 A1
(43) Pub. Date: Jan. 9, 2003

(54) USE OF N-NEOHEXYL-A-ASPARTYL-L-PHENYLALANINE METHYL ESTER AS A FLAVOR MODIFIER

(76) Inventors: PAULA A. GERLAT, HIGHLAND PROK, IL (US); LEORA C. HATCHWELL, BUFFALO GROVE, IL (US); GALE C. WALTERS, VERNON HILLS, IL (US); ANGELA MIRAGLIO, DES PLAINES, IL (US); HAROLD SAWYER, LAKE ZURICH, IL (US)

Correspondence Address: JEFFREY M. HOSTER, c/o THE NUTRASWEET COMPANY, 10 S. WACKER DRIVE, SUITE 3200, CHICAGO, IL, 60606, US

(21) Appl. No.: 09/465,837

(22) Filed: Dec. 17, 1999

Related U.S. Application Data
(60) Provisional application No. 60/112,948, filed on Dec. 18, 1998.

(51) Int. Cl. A23L 1/22

(52) U.S. Cl. 426/534

(57) ABSTRACT

This invention relates to the use of N-[N-(3,3-dimethylbutyl)-L-α-aspartyl]-L-phenylalanine 1-methyl ester, or neotame, as a flavor (taste and/or aroma) modifier, and compositions containing the same.

### BACKGROUND OF THE INVENTION

1. Field of the Invention

This invention relates to the use of N-[N-(3,3-dimethyl butyl)-L-α-aspartyl]-L-phenylalanine 1-methyl ester, or neotame, as a flavor modifier, enhancer and potentiator, and compositions containing the same.

2. Related Background Art

Flavor modifiers are substances added to supplement, enhance, or modify the original flavor of a composition. Flavor is defined as the combined perception of taste, smell or aroma and chemical feeling factors. The perception of flavor is a result of the chemical stimulation of receptors in both the oral and nasal cavities. The basic tastes are sweet, sour, salty and bitter. Umami, described by some as another basic taste, enhances the flavor effect of other ingredients and components of the flavor profile. These basic tastes, including Umami and certain trigeminal effects are perceived in the buccal cavity. Aroma may be the smell emanating from food before it is consumed or the flavor perceived while chewing and swallowing a product.

Flavor and/or aroma modifiers may be added to foods (including beverages), personal or household care products, pharmaceutical preparations, or other compositions to increase acceptance of products by enhancing desirable flavors and/or aromas or by masking or eliminating undesirable attributes. Flavor modifiers may be used to alter the taste and/or aroma of ingestible foods, nutraceuticals and pharmaceuticals, as well as oral and personal care products (e.g., mouthwash, toothpaste, cosmetics, perfumes and the like), or products that may be found in and around homes, businesses, and the like. Flavor modifiers may be used in any concentration necessary to achieve the desired taste and aroma profile of a product for a given application. At threshold flavor concentrations and higher, the modifier may contribute its own character to the composition or food product as well as intensifying, modifying or masking the perception of flavor ingredients in the composition or food product or the flavor and/or taste as a whole. At sub-threshold taste concentrations, flavor enhancers or modifiers are used to enhance, supplement, or modify the original taste and/or aroma of a composition without imparting a characteristic taste or aroma of its own.

It has long been a goal to improve the quality of food products and to provide new and different flavor and aroma sensations to such products. Commercial production of foods expected to have a relatively long shelf-life often requires the use of processing conditions, storage conditions and/or addition of ingredients that may produce undesirable off-tastes in the food compositions. Typical solutions to taste problems are ineffective often due to the high cost of ingredients and manufacturing. The use of flavor modifiers could eliminate or substantially reduce the undesirable off-tastes in food compositions as well as improve the overall taste perception of the food and/or provide new and novel taste experiences. Accordingly, it would be desirable to supply a flavor modifier that could provide such flavor improvements and novelty to foods and preferably contribute these benefits in a cost effective manner.

Flavor modification is especially important in the preparation of specialty foods such as “low-calorie,” “low-fat,” “low-sodium” or “non-dairy” foods. Food additives or ingredient substitutes must often be incorporated into such formulations to reduce the caloric, salt, fat and/or cholesterol content of the food. Often, these additives or ingredient substitutes contain off-flavors that must be tolerated by consumers in need of these products. These off-flavors are often masked by the addition of other ingredients, or by including flavor modifiers. Sweet, sour, salty, bitter, acidic, burning, astringent and cooling are the common tastes that may be modified. Modification of other tastes may be necessary or desired depending upon the type of product and its use. For example, in the case of fat-free dairy products, e.g. containing dairy-ingredient substitutes, flavor modifiers must often be used to provide the dairy-like taste associated with conventional dairy products.

Excessive ingestion of sodium, particularly in the form of sodium chloride, has been linked to high blood pressure and premature heart disease. Therefore, low-sodium foods are often required by individuals having heart disease. Although there are several compounds that are known to have a salty taste, flavor problems are associated with their use as salt substitutes. Currently, reduction of sodium intake is achieved via a combination of abstinence, use of sodium chloride substitutes and/or mixing sodium chloride with other salts and/or fillers. Each of these methods provides foods having a reduced sodium concentration and a reduced salty taste quality. Because of flavor problems with these products, patient compliance is often low. For example, potassium chloride has an undesirable pronounced bitter taste. To date, there are no universally satisfactory substitutes for sodium chloride. Accordingly, it would be advantageous to develop an ingredient that modifies flavor and provides an increase in saltiness taste perception, masks undesirable bitter notes associated with the use of salt substitutes, and/or improves the onset and perception of the salty taste.

Not only do some additives and ingredient substitutes have bitter and/or undesirable tastes, often primary food ingredients and flavoring ingredients possess undesirable flavors that reduce the quality and consumer acceptance of the foods. Teas, coffee, juices and other beverages often have bitter, acidic, astringent and flavor off-notes that may be masked or muted by the addition of ingredients to improve the taste quality of the beverage. Flavor modifiers provide the dual benefit of masking or muting undesirable tastes as well as reinforcing and strengthening desired tastes for a given product type.

Good tasting nutritional supplements and lactose-free dairy products, such as milk and ice cream-like lactose-free products, are in demand by individuals desiring alternative nutrition as well as those suffering from lactose intolerance. soy ingredients, often used to prepare lactose-free products and nutritional supplements, often are characterized by a beany, painty, alkaline, raw or sour taste and flavor profile. Commonly, the attempts to improve the taste and flavor of products containing soy ingredients involve the addition of extra ingredients that add sweetness or other distinct flavors to the soy product. The effect of using these additives is to provide a soy product having a flavor character that is less dairy-like. Use of flavor modifiers, rather than flavoring ingredients, to improve the flavor profile of soy products could provide the benefit of masking or muting undesirable notes.

The bitterness and other undesirable off-notes of some food compositions and many medicinal or pharmaceutical preparations often reduce patient compliance with completing a prescribed course of treatment. Flavorings may be added to partially mask the bitter taste or aftertaste of these materials. However, many of these flavorings either are not effective in adequately masking the bitter or undesirable off-tastes, or are not compatible with the compounds or other materials present in the medicinal or pharmaceutical preparation. Accordingly, it would also be desirable to provide a flavor modifier that could eliminate or substantially reduce the bitterness and off-tastes in food compositions, medicinal and pharmaceutical preparations. Therefore, it would be desirable to develop a flavor modifier that would function to both enhance desired flavors and aromas and reduce off-notes.

### SUMMARY OF THE INVENTION

This invention relates to compositions containing N-[N-(3,3-dimethylbutyl)-L-α-aspartyl]-L-phenylalanine 1-methyl ester, or neotame, of the formula

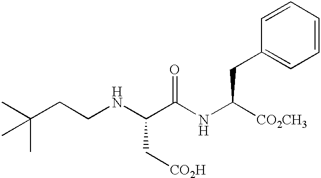

including salts thereof, crystalline forms thereof, and formulations thereof, to alter and improve the flavor or aroma of the composition. Although neotame is a known high intensity sweetener, it has now been discovered that neotame is particularly useful for modifying, improving and/or enhancing the overall flavor or aroma of compositions. Specifically, neotame may be used above, at, or below sweetness taste threshold amounts to modify, improve and/or enhance the flavor of compositions. Neotame is particularly effective in modifying, improving and/or enhancing the following flavors: saltiness, tartness (sourness or acidic), vanilla, mint, spices, herbs, citrus and other fruit flavors, cocoa, dairy and savory flavors, eliminating or reducing bitter flavors, aftertastes or bitter off-notes, masking, reducing or eliminating other off-notes, and modifying and rounding out the flavor of various compositions, or of ingredients used therein. Neotame may be used to modify and enhance the aroma of ingestible products, products not intended for ingestion, and compositions used in the preparation thereof.

This invention also relates to the method of preparing compositions containing an effective amount of neotame to modify the taste and/or aroma properties of the compositions. According to the method of this invention, neotame may be added to a composition to improve the flavor and/or aroma of that composition.

### DETAILED DESCRIPTION OF THE INVENTION

This invention relates to the use of N-[N-(3,3-dimethylbutyl)-L-α-aspartyl]-L-phenylalanine 1-methyl ester, or neotame, to modify the flavor, that is the taste and/or aroma properties, of compositions. Neotame has been found to act as a flavor modifier to change the taste and/or aroma profiles of compositions when added to a wide variety of food and pharmaceutical compositions, as well as personal care, oral care and other household products. Neotame has also been found to act as a flavor and/or aroma modifier to change the taste and/or aroma profiles of flavor compositions that may be used in the preparation of food compositions, pharmaceutical compositions, personal care products, oral care products and other household products. For purposes of this patent, a flavor modifier is an ingredient that changes the taste and/or aroma of a composition by enhancing, suppressing or modifying the impact or profile of at least one taste or aroma of the composition or by reducing, eliminating or masking off-notes, undesirable aftertastes or the harsh impact of at least one taste or aroma of the composition. This sweetener, disclosed in U.S. Pat. No. 5,480,668, is approximately 8,000 times as sweet as sucrose, on a weight basis. Thus, very small quantities of this sweetening agent may be used to sweeten foods without adding calories. The threshold taste concentration of neotame in a composition is the concentration at which the sweetness provided by neotame can be detected. For example, in beverage formulations, a typical sweetness level is 10% by weight sugar. In water sweetened with 10% sugar, the threshold taste concentration of neotame has been determined to be approximately 4 parts per million (ppm). However, for each application, the taste threshold level of neotame will vary depending on the physical form of the composition (e.g., solid, semi-solid, liquid or gel), as well as on the presence of other ingredients in the composition. The ability to determine this threshold level is well known in the art. According to this invention, compositions containing neotame, whether present in the compositions above, at, or below threshold taste concentrations, possess enhanced or improved flavor (taste and/or aroma), compared to those compositions without neotame. The enhanced or improved taste, according to this invention, is in addition to, and is different from the sweet taste provided by neotame at, or above sweetening threshold concentrations.

According to the method of this invention, N-[N-(3,3-dimethylbutyl)-L-α-aspartyl]-L-phenylalanine 1-methyl ester may be added to a composition to modify the flavor profile of that composition. The neotame used in this invention may take any form. For example, it may be a salt or complex such as described in U.S. patent application Ser. No. 09/146,963, U.S. patent application Ser. No. 09/146,964, U.S. patent application Ser. No. 09/148,134, U.S. patent application Ser. No. 09/146,965, and U.S. patent application Ser. No. 09/154,568, the disclosure of each of which is incorporated by reference herein. Other exemplary forms of neotame that may be used in this invention include co-crystallized forms and cyclodextrin complexes, such as described in U.S. patent application Ser. No. 09/154,568 and U.S. Provisional Patent Application No. 60/100,867, the disclosures of each of which are incorporated by reference herein. Advantageously, neotame has been shown to modify, enhance and/or improve the taste and/or aroma of a wide variety of flavoring ingredients. Neotame can modify, enhance and/or improve the taste and/or aroma of individual flavoring ingredients or other flavor enhancing ingredients, of different chemical structural classes, as well as more complex flavoring ingredients, such as natural essential oils, plant and or botanical extracts (e.g., compositions obtained by extracting or expressing a any vegetative material), without distorting the inherent flavor profiles of these ingredients. These ingredients may also be used as nutraceuticals. Moreover, when used at sub-threshold concentrations, neotame does not contribute any of the bitter, metallic, licorice, sulfur or other flavor defects commonly associated with use of certain other high potency sweeteners as flavoring ingredients and other flavor modifiers.

The general effect of neotame on taste and/or aroma is to modify bitter and harsh off-notes, which results in compositions having a more rounded and brighter taste and/or aroma. Neotame may eliminate or significantly reduce bitter tastes, bitter aftertastes and/or bitter off-note flavors of compositions, such as foods (including beverages), medicinal or pharmaceutical compositions, oral care products, and the like, and may be particularly useful in enhancing the taste of such products containing other high intensity sweeteners that contribute their unique flavor defects to the compositions. specifically, neotame has been found to eliminate or substantially reduce stale, and cardboard-like tastes, burnt, woody and harsh flavor notes, bitter tastes (e.g. the bitter off-taste of caffeine or cocoa) and chemical off-tastes (e.g., of medicinal compositions, plant extracts, artificial flavorings, high intensity sweeteners, chemically treated ingredients and the like). By reducing or eliminating the bitter tastes of these compositions, or of ingredients included therein, other more desirable tastes and/or aromas may be perceived. Accordingly, use of neotame can improve the overall taste and/or aroma perception of these compositions.

The use of neotame significantly enhances the effect of particular flavoring ingredients, such that reduced amounts of flavoring ingredients may be used to flavor a composition. Accordingly, neotame provides an ingredient-sparing effect. That is, when used in combination with neotame, reduced quantities of a flavoring ingredient are required to provide a composition having a flavor equivalent to that of a composition prepared without neotame. Thus, the amount of ingredient spared is the difference in the amount of that ingredient required to flavor a composition when combined with neotame from the amount of that ingredient normally required to flavor the composition. Accordingly, the amount of a flavoring ingredient used to flavor a composition may be reduced by as much as about 10% to about 60% by weight, when used in the presence of neotame. The neotame may be present in such compositions in any amount described herein.

Neotame has been found to modify, improve or enhance the tartness, or sourness, of compositions. Tartness, sourness and acidic taste are synonyms for the basic taste typically provided by acidic ingredients. A composition, such as a carbonated beverage or a salad dressing, containing neotame above, at, or below sweetness taste threshold concentrations, in combination with an acid, will have a stronger sour taste, or tartness, than the composition containing an equal concentration of the acid alone. Thus, less acid may be used to provide a strong desirable tartness, when used in the presence of neotame. Neotame may modify, enhance or improve the sourness of the following exemplary acids: citric acid, acetic acid, phosphoric acid, tartaric acid, malic acid, fumaric acid, lactic acid, adipic acid and the like. For example, it has been found that a composition containing 0.28% by weight citric acid has the same tartness as a composition containing 14 ppm neotame and approximately 30% less citric acid. Accordingly, neotame may be used to reduce the concentration of acid in an acid-containing composition.

Use of neotame provides for the preparation of compositions having good acidic perception and containing a decreased amount of acid. That is, neotame provides for the preparation of compositions having a crisp tartness that have a higher pH than conventional tart compositions. This effect is particularly important for the preparation of compositions that contain or that could contain acid-sensitive ingredients. Reduction in the acid concentration in foods may provide for savings in ingredient costs. For example, carbonated beverages typically have a pH of about 3.0 to about 4.5 and often contain mixtures of citric acid and phosphoric acid at concentrations effective to maintain the desired pH range for the beverage. The present invention provides a means of preparation of an equally tart carbonated beverage by formulating with neotame, which allows for the reduction in the concentration of phosphoric acid, citric acid, malic acid, fumaric acid, lactic acid, adipic acid and the like and an increase in pH of the beverage. Reducing the acidity of certain compositions may also provide for the formulation of foods containing acid sensitive ingredients or that may be prepared or consumed at relatively high temperatures (compared to foods that are frozen or consumed at room temperature); the reduced acidity may enhance the stability of acid sensitive ingredients such that these materials will remain stable in the foods or remain stable at elevated temperatures. For example, aspartame, a commonly used sweetener, slowly degrades in strongly acid media, such as found in beverages. The reduced acid content and increased pH of the carbonated beverage containing neotame results in a slower degradation rate for aspartame present in the beverage. Accordingly, a more stable aspartame-sweetened beverage may be prepared by incorporating neotame, in above, at, or below taste threshold amounts, and reducing the amount of the acid typically used in the acid-containing beverage.

Neotame may be used to further modify, enhance or improve the taste profile of compositions containing flavor potentiators such as salts, monosodium glutamate, or the seasoning material described in U.S. Pat. No. 5,843,514, the disclosure of which is incorporated herein by reference. Neotame has been found to modify the saltiness perception of compositions containing salts, such as sodium chloride or potassium chloride. Particularly, it has been found that flavored compositions containing neotame, above, at, or below sweetness taste threshold concentrations, in combination with salt (sodium chloride) or a salt substitute (potassium chloride) may have a saltier taste than the flavored composition containing an equal concentration of the salt or salt substitute, alone. Often, to provide the best flavor for neotame- and salt-containing flavored compositions, the salt concentration must be reduced. Thus, in these flavored compositions, neotame has been found to have a salt-sparing effect—that is, when used in combination with neotame, less salt is required to provide a composition having a taste profile similar to the composition obtained using the salt alone. Examples of such flavored compositions include flavored food and pharmaceutical compositions containing flavor enhancing amounts of salt, that is compositions having a non-salty flavor (e.g., hot chocolate drinks) as well as flavored food and pharmaceutical compositions wherein the salt functions to enhance the flavor of the composition and/or to provide a salty taste (e.g., salted potatoes). For example, it has been found that a reconstituted hot chocolate drink, containing neotame and salt, had the best flavor when the composition of the cocoa mix was modified such that the amount of cocoa was reduced by about 6% and the amount of salt was reduced by about 40% to about 60%. It has also been found that reconstituted instant potatoes containing both sodium chloride and neotame had a similar potato flavor impact and was as salty as the reconstituted instant potatoes that contained about 30% by weight more sodium chloride, without added neotame.

Advantageously, neotame has also been found to modify and improve the salty taste of sodium chloride, potassium chloride, and sodium chloride/potassium chloride blends. Addition of neotame to aqueous solutions containing these salts provided an overall enhancement and improvement of the saltiness perception, wherein the salty taste became more even and rounded, with a reduction in the impact of the harsh salty notes. Moreover, because neotame also reduces bitter tastes and bitter aftertastes, use of neotame with salt substitutes, such as potassium chloride, provides compositions with a clean salty taste that also have a reduced sodium ion concentration. Accordingly, neotame provides the dual benefit of improving saltiness perception and providing good tasting flavored compositions having reduced salt concentrations, when added to compositions containing one or more salts.

Neotame has been found to modify, enhance or improve the taste and/or aroma of a broad range of individual flavor ingredients, as well as complex flavors (e.g., finished flavors, natural essential oils, plant extracts and botanicals) without distorting the balance of the various components of the flavors. Generally, flavors may be categorized into the following aromatic and non-aromatic chemical classes: acetylenes, alcohols, aldehydes, amines, carboxylic acids, esters, lactones, ethers and acetals, heterocycles (pyrroles, quinolines, furans, thiophenes, thiazoles, indoles, pyridines, pyrazines, and the like), hydrocarbons, ketones, sulfur-containing ingredient (sulfides, mercaptans, and the like), each of which may be modified, enhanced and/or improved by neotame. Flavors may be also be categorized according to the following descriptor types: balsamic (anise, balsam, caramel, chocolate, cinnamon, honey, sweet, vanilla, and the like), chemical/medicinal, citrus/terpenic (lemon, lime, orange and the like), ethereal, fatty/rancid/waxy/soapy/dairy (butter, cheese, creamy, milky, oily, sour, and the like), floral/sweet, fruity/ester, green/grassy/mossy, minty/camphoraceous, meaty/brothy/animalic/hydrolyzed vegetable proteins (HVP)/vegetable/soupy, roasty/burnt/coffee/nutty, spicy/herbaceous, sulfurous/alliaceous (garlic, onion, and the like), wine-like, and woody/smoky, each of which may also be modified, enhanced and/or improved by neotame. A comprehensive list of flavors may be found in Source Book of Flavors, 2nd Edition, 1997, Gary Reineccius, Editor. The range of flavors enhanced by neotame is not limited to any specific chemical classification nor descriptor. Neotame may be used to enhance any of the following flavoring ingredients: essential oils, oleoresins, tinctures, extracts, botanicals, process or reaction flavors, and mixtures thereof.

Neotame may be used to enhance and/or improve the flavor of natural botanicals, such as licorice, kola nut, foenugreek and the like. Neotame has also been used to enhance and/or improve citrus beverages, naturally containing citrus oils and other citrus flavor ingredients. Neotame has been found to exhibit marked enhancing effects of both the aroma and taste of ginger, as well as mint flavors such as peppermint, spearmint and wintergreen flavors. Neotame also enhances and/or improves the aroma and taste of plant extracts and essential oils, such as vanilla, spice oils, citrus oils, and the like. It has also been found that neotame, in combination with alcohols, such as eugenol (woody clove), hexanol (green fruit), anethole (fennel or licorice), menthol, alpha-terpineol (lime and citrus fruits,) sulfurol (roasted meat), cis-hexenol (strawberry or apple), or phenyl ethyl alcohol (roses), rounds out the overall flavor and/or aroma of these compounds. The aroma of cis-hexenol is improved by reduction in the harsh chemical off-notes, whereas improvement in the aroma of phenyl ethyl alcohol is improved by rounding the rosy/floral character and by reducing the honey and grape-like nuances. Use of neotame with aldehydes, such as hexanal (citrus and fresh orange), decanal (citrus and orange), trans-2-hexenal (green nuances to fruit and vegetable flavors), benzaldehyde (almond), cinnamic aldehyde (cinnamon), citral (lemon) and the like, results in reduction in the waxy nuances, harsh chemical notes in the flavor and/or aroma and enhances or brightens the dominant character notes of the flavor chemical. It has been found that neotame, in combination with carboxylic acids, such as acetic acid (vinegar), butyric acid (dairy) and 2-methyl-2-pentenoic acid (tangy depth of strawberry) and the like, rounds out the acid harshness and enhances the acidic or tartness perception of these acidic ingredients. Use of neotame with esters, such as ethyl butyrate (citrus and fruit top notes), isoamyl acetate (banana), methyl anthranilate (grape), ethyl maltol (caramel, cotton candy, strawberry jam), ethyl vanillin (vanilla) and the like, results in reduction in the chemical, harsh, green and burnt notes in the flavor and/or aroma and provides a more rounded, balanced profile that is typically sweeter and more fruity than that of the esters, without neotame. Similar improvements in the flavor profile of acetylenes, amines, lactones, ethers and acetals, heterocycles (pyrroles, quinolines, furans, thiophenes, thiazoles, indoles, pyridines, pyrazines, and the like), hydrocarbons, ketones, and sulfur-containing flavor ingredients (sulfides, mercaptans, and the like) may be obtained. Specifically, improvements in the aroma and/or taste of the following materials have been observed: methyl amyl ketone, diacetyl (2,3-butanedione), ionone alpha (4-(2,6,6-trimethyl-2-cyclohexen-1-yl)-3-buten-2-one), raspberry ketone (4-p-methoxyphenyl-2-butanone), gamma octalactone (4-hydroxy-octanoic acid-gamma-lactone), delta decalactone (5-hydroxy-decanoic acid-delta-lactone), delta dodecalactone (5-hydroxy-dodecanoic acid-delta-lactone), delta tetradecalactone (5-hydroxy-tetra-decanoic acid-delta-lactone), 2,3-dimethylpyrazine (2,3-dimethyl-1,4-diazine) 2-acetylpyrazine, quinine (quinine sulfate), maltol (3-hydroxy-2-methyl-gamma pyrone), and caramel color (double strength).

It has been discovered that the flavor of vanilla is particularly enhanced by addition of neotame to compositions containing vanilla flavoring ingredients, such as vanillin, ethyl vanillin, vanilla bean or vanilla extract. A composition containing neotame, above, at, or below sweetness taste threshold concentrations, in combination with a vanilla ingredient has a stronger vanilla taste than a composition containing an equal concentration of the vanilla ingredient alone. Thus, neotame also has a significant vanilla sparing effect—less of a vanilla ingredient is needed to provide a pleasant vanilla taste when used in the presence of neotame. The amount of vanilla ingredient in a composition, when in combination with neotame, may be reduced by about 15% to about 25% by weight of the composition. For example, a composition containing 150 ppm vanillin and 10 ppm neotame has been found to have the same vanilla taste as a composition containing 180 ppm of vanillin, without neotame. As described in the examples below, neotame also enhances and improves the aroma of vanilla. Accordingly, when used with neotame, reduced quantities of a vanilla flavoring ingredient provides a rounded, more pleasant and high impact vanilla flavor.

Mint flavors, particularly spearmint, peppermint, and wintergreen are also significantly enhanced by combination with neotame. A composition containing neotame, above, at, or below sweetness taste threshold concentrations, in combination with mints or mint ingredients has a stronger, cleaner minty taste than a composition containing an equal concentration of mints or mint ingredients alone. Neotame also significantly enhances and improves the aroma of mints and mint ingredients, by enhancing the fresh green and/or minty cool nuances and reducing the weedy character of the flavoring. Neotame also has a significant sparing effect on mint. The amount of mint or mint ingredient in a composition, when used in combination with neotame, may be reduced by as much as about 25% by weight of the composition to provide a composition having a superior freshness and minty impact and taste profile. Accordingly, when used with neotame, reduced quantities of a mint or mint ingredients provide a rounded, more pleasant and desirable high impact mint flavor.

In addition, neotame has been found to enhance the flavor of chocolate in chocolate-flavored products, e.g. pie fillings, hot cocoa mixes, and the like. Typically, when neotame is present in cocoa and/or chocolate-containing products, the amount of the cocoa or chocolate ingredient required to provide a good chocolate taste may be reduced by about 5% to about 10% by weight. Accordingly, neotame may be a particularly useful flavor modifying ingredient for vanilla and chocolate flavored dairy or dairy-like products.

As well, neotame has been found to provide a dairy impression in soy-containing products. Addition of neotame at concentrations less than 3 ppm to soy-containing food products, reduces or eliminates alkaline, beany, painty and sour soy off-flavors and improves the flavor of the soy-containing product by adding a fresh, pasteurized milk-like character, without adding calories, sweetness or introducing non-dairy flavors. Accordingly, neotame may be a useful flavor modifying ingredient for soy-containing products, and may be especially useful as a flavor-modifying ingredient for all soy-containing products. Because of the drastic suppression of soy off-flavors, more soy ingredient may be added, thereby improving the nutritional benefit of such products.

Neotame has been found to modify, enhance and/or improve the flavor of savory ingredients and products. Savory ingredients and products are those ingredients and products that are normally not sweet, but are spicy, cheesy, meaty, salty, and/or cause salivation. The savory ingredients are used to accentuate the inherent flavor of one or more base ingredients present in a food composition. These savory ingredients may result in beef, chicken, pork, fish, or generic meaty flavors, as well as cheese and spice notes. Examples of these ingredients are processed or reaction flavors (e.g., Maillard processed flavors), hydrolyzed vegetable proteins (HVP), monosodium glutamate, ribotides, soy proteins, yeast extracts, autolyzed yeast extracts, meat analogs, cheeses and cheese analogs, cheese powders and the like. Examples of savory products are gravies and sauces, salad dressings, au jus, and the like.

Neotame is also useful for modifying the aroma of compositions not intended for ingestion. For example, neotame may be useful for enhancing and improving the aroma of perfumes, pet products, air fresheners, cleaning products, pastes, creams, ointments, and the like.

This invention also provides for compositions containing neotame, as a flavor (taste and/or aroma) enhancer or modifier or an aroma enhancer or modifier, wherein undesirable tastes and/or aromas are reduced or eliminated, or wherein desirable tastes and/or aromas are modified, enhanced and/or improved. The compositions of this invention, containing neotame, include ingestible products, such as food compositions and medicinal or pharmaceutical compositions, as well as topical and personal care compositions (e.g., mouthwash, oral care, perfumes and the like) or household compositions, not intended for ingestion, that may be found in and around homes, businesses and the like (e.g. perfumes, pet products, air fresheners, cleaning products, pastes, creams, ointments, or other products that may be enhanced by the addition or enhancement of scent). The food compositions of this invention include both solid, semi-solid, gel and liquid ingestible materials which usually do, but need not, have nutritional value. Thus, the food compositions of this invention, containing neotame in flavor-modifying effective amounts, include, but are not limited to, soups, sauces, gravies, condiments, dressings, frostings, convenience foods, including tomato sauces, macaroni and cheese products, meat products, beverages, including soft drinks, fruit juice-containing drinks, fruit-flavored drinks, carbonated soft drinks, flavored waters, soy-based drink products, teas, coffees and coffee-flavored drinks, dairy products, such as toppings, puddings, milk drink products, frozen desserts, cultured products (for example, yogurt and cultured cheese products) and processed cheese products (including cheese sauces), confections (including chewing gum), snack foods, vegetables, cereals, bakery products, cocoa- or chocolate-containing products, such as hot cocoa beverages or any of the above-described products that may contain cocoa or chocolate, and the like. These compositions also include: syrups, such as chocolate syrups, strawberry syrups and butterscotch syrups, sauces, such as barbecue sauce, hickory-flavored barbecue sauce, brown sauce, tomato sauce, herb-flavored tomato sauce, parmesan sauce and cheese sauce, salad dressings, such as, Italian salad dressings and lite Italian salad dressings, puddings, such as vanilla pudding and sugar-free vanilla pudding, gravy, such as beef gravy and pork gravy, soups, such as chicken soup, low-sodium chicken soup, and vegetarian soup, beverages, such as tea, coffee, whitened coffee, carbonated beverages, orange juice, fruit-flavored drinks, such as lemonade, raspberry flavored drinks and tropical fruit flavored drinks, milk, fat-free milk, milk beverage, soy beverages, flavored dietary supplement beverages, nutrition beverages, sports drinks, soft drinks, and hot cocoa beverages, fillings and frostings, such as, cheese cake filling, whipped topping, pie filling, chocolate pie filling and sugar-free pie filling, pie crusts, such as graham cracker crusts, confectioneries, macaroni and cheese products, meat products, vegetable products, soy-containing products, and cocoa- or chocolate-containing products. Medicinal or pharmaceutical products include tablets, syrups, liquid formulations, cough drops, chewable tablets, nutraceuticals and the like. Medicinal and pharmaceutical products include compositions that are available only by prescription as well as compositions that are available over the counter, such as non-prescription drugs, oral-care products, food supplements, nutraceuticals, herbal remedies, such as plant extracts, and the like. These products often contain ingredients having very bitter or undesirable tastes and/or aromas which may be preferably eliminated or reduced.

This invention also contemplates ingredient compositions, containing neotame, that are used in the preparation of other compositions. Accordingly, the compositions of this invention also include flavor compositions, comprising neotame, together with one or more flavoring ingredients, wherein the neotame is present in an amount sufficient to modify the taste and/or aroma of the flavor ingredient. These compositions may be in any physical form, such as solid, semi-solid, gel, paste or liquid form. The flavor compositions of this invention comprise flavor ingredients selected from the group comprising: acetylenes, alcohols, aldehydes, amines, carboxylic acids, esters and lactones, ethers and acetals, heterocycles (pyrroles, furans, thiazoles, pyridines, pyrazines, and the like), hydrocarbons, ketones, and sulfur containing ingredient (sulfides, mercaptans, and the like), essential oils, oleoresins, tinctures, extracts, botanicals, process flavors, and mixtures thereof. The flavor compositions of this invention may comprise neotame together with one or more of following flavor ingredients: black strap molasses, licorice, kola nut, foenugreek, citrus oils, such as lemon oil, lime oil or orange oil, whether expressed or extracted, mint flavors, such as peppermint, spearmint and wintergreen, vanilla, spice oils, such as cassia, ginger, nutmeg, and the like, eugenol, hexanol, anethole, menthol, alpha-terpineol, sulfurol, cis-hexenol, phenyl ethyl alcohol, hexanal, decanal, trans-2-hexenal, benzaldehyde, cinnamic aldehyde, citral, acetic acid, butyric acid, 2-methyl-2-pentenoic acid, ethyl butyrate, isoamyl acetate, methyl anthranilate, ethyl maltol, methyl amyl ketone, diacetyl (2,3-butanedione), ionone alpha (4-(2,6,6-trimethyl-2-cyclohexen-1-yl)-3-buten-2-one), raspberry ketone (4-p-methoxyphenyl-2-butanone), gamma octalactone (4-hydroxy-octanoic acid-gamma-lactone), delta decalactone (5-hydroxy-decanoic acid-delta-lactone), delta dodecalactone (5-hydroxy-dodecanoic acid-delta-lactone), delta tetradecalactone (5-hydroxy-tetra-decanoic acid-delta-lactone), 2,3-dimethylpyrazine (2,3-dimethyl-1,4-diazine) 2-acetylpyrazine, quinine (quinine sulfate), maltol (3-hydroxy-2-methyl-gamma pyrone), and caramel color (double strength), hydrolyzed vegetable protein, yeast, autolyzed yeast extracts, and the like.

Although neotame may be used in compositions with any other flavoring or food ingredient, it is especially preferred to use neotame in compositions, such as soy products and cocoa products, which have inherently undesirable flavors and which are improved by neotame. When neotame is used in the preparation of these conventionally bitter and off-tasting compositions, an improved composition is obtained having none of the bitterness, off-notes or at least a substantial reduction of the bitterness and off-notes conventionally associated with these compositions.

As will be appreciated by those skilled in the art, the amount of neotame employed in a particular instance to achieve a particular effect can vary over a relatively wide range. The primary requirement is that the amount of neotame selected is sufficient to augment or modify the taste and/or aroma characteristics of a composition. The concentration of neotame employed to reduce the undesirable tastes and/or aromas in any given instance will vary depending on the particular substance or substances having the undesirable tastes/aromas, as well as the presence of other tastes and aromas in the composition. The concentration of neotame employed to enhance, modify, or improve desirable tastes and/or aromas in any given instance will also vary depending on the particular substance or substances having the desirable tastes/aromas, as well as the presence of other tastes and aromas in the composition. In most instances, neotame may be present in the compositions of this invention in amounts of from about 10 ppb to about 1800 ppm to modify the flavor and/or aroma perception thereof. Preferably, neotame may be present in compositions of this invention in amounts of from about 10 ppb to about 1000 ppm, and more preferably, in amounts of from about 25 ppb to about 600 ppm, to enhance, modify and/or improve the taste and/or aroma perception thereof. Neotame may also be present in the compositions of this invention in amounts of about 50 ppb to about 600 ppm, or 100 ppb to about 500 ppm, to enhance, modify, and/ot improve the taste and/or aroma perception thereof.

Advantageously, neotame may be used to modify taste and/or aroma characteristics of a composition when present in an amount that does not sweeten the composition. The threshold taste concentration of neotame in sweetened (10%) water is approximately 4 ppm. However, the sweetness taste threshold concentration of neotame may be greater than or less than about 4 ppm (e.g., 20 ppm) depending on the physical characteristics (solid, liquid, semi-solid form) or the presence of other components present in the food or composition to which the neotame is added. The determination of the sweetness taste threshold concentration of neotame in a composition is considered to be within the ordinary skill of one in the art. Optionally, neotame may be present at below taste threshold concentrations in these compositions in amounts of from about 10 ppb to less than about 20 ppm. Preferably, neotame may be present in sub-threshold taste amounts of from about 10 ppb to less than about 15 ppm, more preferably, in amounts of from about 25 ppb to less than about 10 ppm, and even more preferably, in amounts of from about 25 ppb to less than about 5 ppm. Neotame is an effective flavor modifying ingredient when used at very low concentrations, that is concentrations that are substantially below the sweetness taste threshold of neotame. For example, neotame may be used as an effective flavor modifying ingredient when used in amounts of from about 10 ppb to less than about 4 ppm, from about 50 ppb to about 4 ppm, from about 100 ppb to about 4 ppm, from about 25 ppb to about 3 ppm, from about 25 ppb to about 2 ppm, from about 50 ppb to about 2 ppm, from about 50 ppb to about 1 ppm, or from about 50 ppb to about 0.5 ppm.

Preferably, the compositions of this invention possess flavors selected from the group comprising: balsamic (anise, balsam, caramel, chocolate, cinnamon, honey, sweet, vanilla, and the like), chemical/medicinal, citrus/terpenic (lemon, lime, orange and the like), ethereal, fatty/rancid/waxy/soapy/dairy (butter, cheese, creamy, milky, oily, sour, and the like), floral/sweet, fruity/ester, green/grassy/mossy, minty/camphoraceous, meaty/brothy/animalic/hydrolyzed vegetable proteins(HVP)/vegetable/soupy, roasty/burnt/coffee/nutty, spicy/herbaceous, sulfurous/alliaceous (garlic, onion, and the like), wine-like, and woody/smoky. Preferred compositions of this invention possess flavors selected from salty, savory, fruity, acidic, vanilla, mint, spice (such as, ginger), citrus, cocoa, chocolate and dairy. Other preferred compositions also include those having undesirable flavors that are specifically reduced, masked or eliminated by addition of neotame. Neotame may be used to enhance the taste and/or aroma of beverages (soft drinks, fruit drinks, carbonated soft drinks, flavored waters, iced teas, and the like), confections, oral care products, nutraceuticals, cocoa- or chocolate-containing products (e.g. hot cocoa, pie fillings, and the like), dairy products (toppings, puddings, milk drink products, cheese- products, soy-based drink products, and the like), vanilla containing products, soups, sauces, gravies, meat products, bakery products, snack foods, cereals, vegetables, frostings, and the like.

A carbonated beverage prepared according to this invention may contain about 10 ppb to about 100 ppm neotame in the beverage. Preferably, the beverage may contain about 50 ppb to about 75 ppm neotame and more preferably, the beverage may contain about 100 ppb to about 50 ppm neotame. The presence of the neotame allows for the formulation of a beverage containing about 20% less acid than typical carbonated beverages without loss of the desirable acidic taste. Alternatively, a carbonated beverage according to this invention, having enhanced and/or improved taste and/or aroma, may contain about 10 ppb to about 15 ppm neotame. Preferably, the beverage may contain about 25 ppb to about 10 ppm neotame, or about 25 ppb to about 5 ppm.

An orange juice drink prepared according to this invention may contain about 100 ppb to about 15 ppm neotame in the beverage. Preferably, the beverage may contain about 0.5 ppm to about 10 ppm neotame, and more preferably, the beverage may contain about 0.8 ppm to about 5 ppm neotame. The presence of the neotame allows for the formulation of an orange juice, or a reconstituted orange juice drink having a brighter, fresh squeezed citrus flavor and aroma.

Confectionery products, such as chewing gum, hard candy, soft candy, or nougat, prepared according to this invention may contain about 10 ppb to about 1600 ppm neotame in the confectionery product, or preferably, 10 ppb to 250 ppm neotame. For example, a chewing gum may contain about 50 ppb to about 180 ppm, and preferably, may contain about 100 ppb to about 250 ppm neotame, or about 100 ppb to about 100 ppm neotame. A mint-flavored, neotame-containing chewing gum according to this invention may also contain about 25% less mint flavoring ingredient than typical mint flavored chewing gums products, and have enhanced mint flavor character.

A tabletop salt substitute composition (e.g. containing 50% maltodextrin and 50% sodium chloride) according to this invention may contain about 0.1 ppm to about 2 ppm neotame. Preferably, the salt composition may contain about 0.1 ppm to about 1 ppm, and more preferably, may contain about 0.25 ppm to about 0.6 ppm neotame, or about 0.3 ppm to about 0.5 ppm. Such a salt-substitute composition has the same saltiness taste intensity as 100% sodium chloride but with an improved salty taste profile.

A whipped topping according to this invention may contain about 50 ppb to about 75 ppm neotame in the topping. Preferably, the topping may contain about 100 ppb to about 50 ppm, and more preferably, the topping may contain about 100 ppb to about 40 ppm neotame, or about 120 ppb to about 40 ppm. This whipped topping may contain about 20% less vanilla flavor than typical whipped toppings with no loss of vanilla flavor.

A vanilla flavored instant pudding according to this invention may contain about 10 ppb to about 75 ppm neotame in the pudding. Preferably, the pudding may contain about 50 ppb to about 60 ppm, and more preferably, the pudding may contain about 100 ppb to about 50 ppm neotame. This vanilla pudding may contain about 20% less vanilla flavor and about 47% less salt than typical instant puddings yet have similar taste and flavor characteristics.

A reconstituted hot cocoa drink, prepared from a dry cocoa mix, according to this invention may contain about 100 ppb to about 25 ppm neotame in the ready-to-drink cocoa. Preferably, the cocoa may contain about 1 ppm to about 20 ppm, and more preferably, may contain about 2 ppm to about 15 ppm neotame. For best flavor, this hot cocoa mix may contain about 6% less cocoa and about 40% to about 60% less salt than typical hot cocoa mixes without loss of the flavor attributes provided by these ingredients.

A no-sugar added chocolate pie filling according to this invention may contain about 100 ppb to about 200 ppm neotame in the pie filling. Preferably, the pie filling may contain about 1 ppm to about 150 ppm, and more preferably, may contain about 5 ppm to about 100 ppm neotame. For best flavor, this chocolate pie filling may contain about 6% less chocolate, about 20% less vanilla extract and about 40% to about 60% less salt than a typical sugar-sweetened chocolate pie filling yet and possess similar taste and flavor characteristics.

When neotame is used to modify and enhance the aroma of ingestible products, such products may contain neotame in a non-sweetening amount of about 10 ppb to about 20 ppm. When neotame is used to modify and enhance the aroma of products not intended for ingestion, such products may contain neotame in an amount of from about 10 ppb to about 1800 ppm.

The compositions described herein may be prepared according to conventional techniques. The compositions may be prepared using any convenient method for incorporating neotame, in any form, into the compositions, or ingredients used therein, in the proportions stated and in a manner suitable to provide the desired consistency, homogeneity of dispersion, etc. of the composition. Neotame, optionally together with other additives, may be dry blended with the composition or dry blended with an ingredient used in the preparation of the composition. For example, neotame may be blended or mixed into powdered drink mixes, salt substitutes, puddings, frostings, dressings, sauces, syrups, gravies, and the like, or may be mixed with other dry or liquid ingredients that are used in the preparation of these compositions. Alternatively, neotame, optionally together with other flavoring ingredients described hereinabove, may be dissolved in a suitable solvent, such as water, water/alcohol, alcohol, propylene glycol, glycerin, triacetin, and the like or may be dissolved in flavor oil mixtures or plant extracts, then added in solution to a composition or combined with an ingredient used in the preparation of the composition. The neotame-containing solution may be sprayed onto the composition, may be blended into the composition, may be blended into or complexed with an ingredient used in the preparation of the composition, the composition may be dipped into the solution or may be spray-dried with another ingredient. Solutions containing neotame, together with one or more flavoring ingredients may also be co-dried and then added as a solid to a composition or combined with an ingredient used in the preparation of the composition. Alternatively, neotame may be admixed with one or more flavoring ingredients then added to a composition or combined with an ingredient used in the preparation of the composition. Other exemplary compositions containing neotame that may be U.S. patent application Ser. No. 09/213,860, U.S. patent application Ser. No. 09/215,460, U.S. patent application Ser. No. 09/215,461 and U.S. patent application Ser. No. 09/213,263, the disclosures of each of which are incorporated by reference herein.

There are several additional ingredients that may be included with the neotame flavor modifier of this invention. Flavoring additives, adjuvants and the like may be conventionally combined with neotame. Such co-ingredients, or adjuvants are well known in the art for such use and have been extensively described in the literature. Apart from the requirement that the co-ingredients are ingestibly acceptable and thus non-toxic or otherwise non-deleterious, conventional materials may be used and broadly include other flavoring ingredients, vehicles, stabilizers, emulsifiers, thickeners, surface active agents, conditioners, flavor intensifiers and encapsulants.

It is anticipated that the use of neotame as a flavor modifying ingredient will require the re-formulation of some of the compositions. Because certain ingredient flavors may be enhanced in a composition of this invention, reduction in the amounts of those ingredients used to prepare the composition may be preferred. For example, as illustrated in Example 103, for best taste, a chocolate pie filling containing neotame as both a sweetener and a flavor modifier, contains 6% less chocolate, 20% less vanilla extract and 40-60% less salt, compared to a sugar sweetened pie filling. It is considered within the skill of one in the art to adjust ingredient use and formulations in the preparation of the compositions of this invention to not only take advantage of the ingredient-sparing effect provided by neotame, but also to optimize the flavor balance of flavor modified compositions containing neotame.

The Examples which follow are intended as an illustration of certain preferred embodiments of the invention, and no limitation of the invention is implied.

Solutions of the flavor materials described hereinbelow were prepared by dissolving the material in filtered water. Solutions of organic flavor materials, that were not directly soluble in water, were first prepared as a 1.0% ethanol solution, using anhydrous ethanol. These solutions were then diluted with neotame-containing charcoal-filtered tap water, such that the final neotame concentration of the tasting composition was 0.5, 1.0 or 2.0 ppm. Neotame was incorporated into commercially available food products, (e.g., tomato sauce, puddings, whipped toppings, etc.), milk-based compositions and the like, by addition of a solution of neotame-containing filtered water in an amount sufficient to provide a testing composition with a desired neotame concentration (e.g., as stated in the Examples). The tasting compositions were then allowed to age overnight prior to being evaluated.

### EXAMPLE 1

Addition of 50 ppb of neotame to barbecue sauce masked the bitterness and mellowed the woody and smoky flavor of the sauce, as compared to a sauce without neotame.

### EXAMPLE 2

Addition of 50 ppb of neotame to hickory-flavored barbecue sauce masked the bitterness and mellowed the woody and smoky flavor of the sauce.

### EXAMPLE 3

Addition of 50 ppb of neotame to tomato sauce reduced the tomato sharpness of the sauce and provided a tomato sauce with a smoother flavor with increased top/green notes.

### EXAMPLE 4

Addition of 50 ppb of neotame to herb-flavored tomato sauce reduced the tomato sharpness of the sauce and provided a tomato sauce with a smoother flavor with increased top/green notes, compared to a herbed sauce without neotame.

### EXAMPLE 5

Addition of 50 ppb of neotame to an Italian salad dressing reduced vinegar harshness, masks the cardboard taste and increases the herb perception of the salad dressing.

### EXAMPLE 6

Addition of 50 ppb of neotame to a lite (reduced-fat) Italian salad dressing reduced vinegar harshness, masks the cardboard taste and increases the herb perception of the salad dressing.

### EXAMPLE 7

Addition of 50 ppb of neotame to chocolate syrup reduced the bitterness and mellowed the flavor of the syrup.

### EXAMPLE 8

Addition of 50 ppb of neotame to strawberry syrup brightened the flavor and lifted the top notes of the syrup.

### EXAMPLE 9

Addition of 50 ppb of neotame to butterscotch syrup mellowed and balanced the flavor of the syrup.

### EXAMPLE 10

Addition of 50 ppb of neotame to a graham cracker crust reduced grain notes and increased the buttery notes and slightly increased the saltiness of the crust.

### EXAMPLE 11

Addition of 50 ppb of neotame to cheesecake filling reduced the diacetyl, cardboard, artificial cheese notes, bitter and soapy taste of the filling and provided a filling having an increased fresh flavor.

### EXAMPLE 12

Addition of 50 ppb of neotame to a vanilla pudding, sweetened with sugar, reduced the cardboard, cloying sweetness and soapy taste of the pudding and provided a pudding having a more balanced flavor.

### EXAMPLE 13

Addition of 50 ppb of neotame to a sugar-free and fat-free vanilla pudding (sweetened with acesulfame-K and aspartame) reduced the bitter burnt and harsh off-note flavors of the pudding, thereby lifting the flavor of the pudding.

### EXAMPLE 14

An aqueous solution of 0.13% (1300 ppm) sodium chloride and 2 ppm of neotame had a more even and balanced salty taste than a 0.13% solution of sodium chloride alone.

### EXAMPLE 15

An aqueous solution containing 0.3% by weight of a lite salt (50:50 NaCl:KCl blend) and 0.50 ppm of neotame had a substantially reduced metallic flavor than a 0.3% solution the lite salt (50:50 NaCl:KCl blend) alone, with virtually none of the bitterness normally associated with potassium chloride.

The unpleasant potassium aftertaste was further reduced using 1.0 ppm neotame. No sweetness was detected, but a slight tingle was evident. Adding 2.0 ppm neotame to the Lite Salt solution provided a similar reduction in the potassium aftertaste, with the addition of a slight sweetness.

### EXAMPLE 16

Addition of 0.50 ppm of neotame reduced the bitterness and improved the salty taste of an aqueous solution containing 0.3% by weight KCl (potassium chloride).

### EXAMPLE 17

A mixture of 0.35% by weight sodium chloride and 0.35 ppm neotame incorporated into reconstituted instant mashed potatoes, provided the same saltiness taste as use of 0.5% by weight sodium chloride.

### EXAMPLE 18

Caffeine (1,3,7-trimethyl-2,6-dioxopurine) is used to impart astringency and bitterness in beverages. When neotame was added at a concentration of 0.05 ppm (50 ppb) and 1.0 ppm to an aqueous solution containing 55 ppm caffeine, the bitter aftertaste of the caffeine was reduced. At 2.0 ppm, neotame imparted a significant sweetness, thereby further reducing the apparent bitterness of the caffeine.

### EXAMPLE 19

Approximately one-half of the panelists in a bench panel indicated that the bitterness associated with caffeine was reduced by the addition of 12 ppm of neotame to a cola containing 50 ppm caffeine.

### EXAMPLE 20

Addition of 25 ppm of neotame reduced the bitterness of a cola flavored beverage.

### EXAMPLE 21

An aqueous solution containing citric acid, having a pH of 3.0, and 17 ppm of neotame had a substantially identical tartness taste to an aqueous citric acid solution having a pH of 3.2.

### EXAMPLE 22

Addition of 2 ppm of neotame to a 0.1% by weight aqueous solution of fluid extract of kola slightly reduced the chemical shellac aroma nuance, and greatly reduced the bitter taste of the caffeine in the extract solution.

### EXAMPLE 23

Addition of 2 ppm of neotame to a 0.1 wt % aqueous solution of licorice extract imparted a sweeter, more rounded brown botanical aroma note, and rounded and mellowed the woody astringent flavor profile of the extract solution.

### EXAMPLE 24

Addition of 2 ppm of neotame to a 0.1 wt % aqueous solution of foenugreek extract did not noticeably change the aroma of the extract solution. The flavor of the extract solution was slightly sweeter and had a reduced phthalide or celery nuance and a slightly reduced burnt bitterness.

### EXAMPLE 25

Addition of 2 ppm of neotame to an aqueous solution containing 25 ppm of distilled peppermint oil significantly enhanced the aroma of the solution. The odor profile was less weedy, more rounded and exhibited a more desirable peppermint stick candy impact. The taste of the solution was similarly enhanced and had a more candy cane lingering coolness.

### EXAMPLE 26

Addition of 2 ppm of neotame to an aqueous solution containing 5 ppm of ginger oil significantly enhanced the aroma of the solution. The odor profile was less woody and musty, and was more spicy, with a fuller, fresher, more desirable ginger character. The taste of the solution was similarly enhanced, being spicier and more peppery, with less musty, woody and raw off-notes.

### EXAMPLE 27

Addition of 2 ppm of neotame to an aqueous solution containing 25 ppm of spearmint oil significantly enhanced the aroma of the solution. The general aroma profile was enhanced, with greatly enhanced fresh green character of the spearmint. Neotame greatly enhances the freshness and impact to provide a spearmint flavor having a superior profile.

### EXAMPLE 28

Addition of 2 ppm of neotame to an aqueous solution containing 1 ppm of asafetida oil reduced the harsh sulfurous top notes by balancing and rounding both the aroma and taste to a more acceptable, better rounded, less metallic character, having a slightly more cooked sulfurous notes.

### EXAMPLE 29

Addition of 2 ppm of neotame to an aqueous solution containing 10 ppm of 3-cis-hexenol mellowed the harshness and rounded out the characteristic green aroma notes, by making the flavor more natural and less chemical in both aroma and taste.

### EXAMPLE 30

Addition of 2 ppm of neotame to an aqueous solution containing 20 ppm of phenyl ethyl alcohol enhanced the aroma of the flavoring ingredient by rounding out the rosy floral notes and reducing the honey and grape-like nuances.

### EXAMPLE 31

Addition of 2 ppm of neotame to an aqueous solution containing 5 ppm of hexanal imparted a significantly less waxy profile while retaining the typical fatty citrus and apple aroma notes. The fruity and citrus tastes are enhanced and more rounded out.

### EXAMPLE 32

Addition of 2 ppm of neotame to an aqueous solution containing 5 ppm of benzaldehyde rounded out the aroma of the flavoring ingredient, by reducing the chemical profile and imparting a slight Prussic acid naturalness to the aroma. Neotame also imparted a fruitier, less chemical, fresher and more characteristic cherry character to the taste of the solution.

### EXAMPLE 33

Addition of 2 ppm of neotame to an aqueous solution containing 5 ppm of cinnamic aldehyde (3-phenyl-2-propen-al), enhanced the aroma profile by rounding out the chemical harshness of the cinnamon character.

Neotame improved the taste of the flavoring ingredient by greatly reducing the chemical harshness and tongue bite and enhancing the sweetness of the ingredient.

### EXAMPLE 34

Addition of 2 ppm of neotame to an aqueous solution containing 20 ppm of ethyl butyrate enhanced the aroma by increasing the fruity, juicy and slightly pineapple-like notes. The taste of the solution was similarly improved, having a more juicy, pineapple, tutti fruitti character.

### EXAMPLE 35

Addition of 2 ppm of neotame to an aqueous solution containing 25 ppm of 2-heptanone rounded out the harshness of the “ketonic” aroma of the flavoring ingredient, by reducing its slightly waxy, fatty nuances and emphasizing its dominant bleu cheese character. The bleu cheese taste profile was more balanced, rounded and enhanced, due to the reduction in harshness and waxiness.

### EXAMPLE 36

Addition of 2 ppm of neotame to an aqueous solution containing 10 ppm of gamma octalactone (4-hydroxy-octanoic acid, gamma lactone), provided a fresher, more natural coconut-like aroma by reducing the waxy, fatty nuances. Similarly, the taste of the solution was improved, being more natural and coconut-like.

### EXAMPLE 37

Addition of 2 ppm of neotame to an aqueous solution containing 25 ppm of delta dodecalactone (5-hydroxy-dodecanoic acid, delta lactone), provided a creamier, more lactonic aroma, having less waxy and fatty nuances. The taste of the solution became more rounded, more naturally creamy and exhibited less of the waxy and fatty nuances typically associated with this flavoring ingredient.

### EXAMPLE 38

Decanal, at a concentration of 10 ppm in water, possessed a citrus-like flavor with waxy, fatty nuances. Addition of 2 ppm neotame noticeably reduced the waxy nuances of the aroma profile and enhanced the flavor profile providing a fruitier orange flavor with reduced fatty notes.

### EXAMPLE 39

trans-2-Hexenal, at a concentration of 10 ppm in water, possessed a green fruity and green vegetable-like taste and aroma. Addition of 2 ppm neotame enhanced the aroma of the aldehyde, making it more natural green fruity/apple-like and reducing the raw herbal fatty green nuances. The taste profile was also enhanced, becoming more rounded and natural in character, with a fresher fruitier profile.

### EXAMPLE 40

Citral (3,7-dimethyl-2,6-octadienal), the characterizing ingredient in lemon oil, at a concentration of 25 ppm in water, had a fruity lemon taste and aroma. Addition of 2 ppm Neotame, enhanced the aroma profile by slightly reducing the chemical top note and improving the freshness of the lemon profile. Neotame provided similar modification of the taste profile of citral, wherein the chemical nuances were reduced and the fruity, juicy citrus lemon peel character was enhanced and rounded.

### EXAMPLE 41

Iso-amyl acetate at a concentration of 20 ppm in water had a distinct banana flavor, with a slightly harsh, green banana fruity aroma. Addition of 2 ppm neotame noticeably rounded the ripe banana fruity character of the aroma. Addition of neotame provided a more completely ripe banana taste that was also sweeter, slightly more brown and less chemical in character.

### EXAMPLE 42

Methyl anthranilate at a concentration of 20 ppm in water had a typically harsh chemical and slightly phenolic aroma, with a Concord grape note. Addition of 2 ppm neotame changed the aroma profile to a more characteristic grape that was less chemical and harsh. The neotame-containing solution had a fruitier grape taste that was much more well rounded and balanced, with a reduced chemical aftertaste.

### EXAMPLE 43

Ethyl maltol at a concentration of 20 ppm in water had a caramellic, cotton candy, strawberry jammy flavor. Addition of 2 ppm neotame reduced the depth of the burnt sugar and brown aroma of the ethyl maltol. Addition of neotame imparted a more natural furaneol-like caramel flavor profile that was less chemical and much less burnt sugar-like.

### EXAMPLE 44

Ethyl vanillin at a concentration of 25 ppm in water had a typical creamy vanilla ice cream taste with a phenolic medicinal nuance in the aftertaste. The aroma of the water solution is chemical, creamy and vanilla-like, with powdery chocolate nuances. Addition of 1 ppm neotame provided a solution having a sweet, creamy vanilla/vanillin aroma, with a powdery, cotton candy, cakey and melted “Dairy Queen” nuances. Addition of 1 ppm neotame provided a solution having a sweet, creamy dairy, candy-like vanilla/vanillin flavor, with cooked yellow cake nuances. The flavor profile was more complex and lingering. Addition of 2 ppm neotame sweetened the top note and imparted a richness and creamy depth to the flavor profile.

### EXAMPLE 45

Diacetyl (2,3-butanedione) at a concentration of 20 ppm in water had a pungent, sweet and slightly caramellic buttery flavor with a cultured fermented starter distillate nuance. Addition of 1 ppm neotame provided a solution having a sweet, mild, and fresh delicate buttery odor, with a lower impacting creamy dairy aroma. The taste was more rounded, having a sweet, creamy, with a drawn browned butter nuance and higher fruity and less harsh cooked nuances. Addition of 2 ppm neotame rounded out and sweetened the aroma profile. The taste of the solution was greatly improved by addition of neotame, becoming sweeter and having an enhanced creamy cakey character. The taste of the solution was greatly improved by addition of neotame, becoming sweeter and having an enhanced creamy cakey character.

### EXAMPLE 46

Ionone alpha (4-(2,6,6-trimethyl-2-cyclohexen-l-yl)-3-buten-2-one) at a concentration of 20 ppm in water had a woody, seedy raspberry like flavor character. Addition of 2 ppm neotame suppressed the “Bug Spray” top note and made both the odor and flavor character less woody and more natural fruity berry.

### EXAMPLE 47

Raspberry ketone (4-(p-methoxy phenyl)-2-butanone) at a concentration of 10 ppm in water possessed a rich raspberry, berry fruity richness with a jammy blueberry and grape nuance. Addition of 2 ppm neotame improved the desirable aroma and flavor profile and reduced its less desirable woody chemical nuances. The flavor profile became more fruity, jammy and well rounded.

### EXAMPLE 48

Tetradecalactone delta (5-hydroxy tetradecanoic acid, delta lactone) at a concentration of 50 ppm in water had a creamy, fatty diary aftertaste, with little or no aroma impact. Addition of 2 ppm neotame smoothed what little aroma was perceived, reducing the waxiness and slight floral nuance. Addition of neotame accentuated the creamy rich aftertaste.

### EXAMPLE 49

2-Acetylpyrazine at 5 ppm in water had a distinct popcorn like flavor. Addition of 2 ppm neotame enhanced and rounded the popcorn and corn chip like aroma and taste.

### EXAMPLE 50

Maltol (3-hydroxy-2-methyl-gamma pyrone) at a concentration of 50 ppm in water had an intense sweet burnt sugar, caramellic, bready, cotton candy/butterscotch flavor. Addition of 2 ppm neotame reduced the extent of the burnt nuance in the cotton candy profile. Addition of neotame reduced the harsh brown, burnt cotton candy sweetness and imparted a fuller jammy strawberry fruity taste.

### EXAMPLE 51

Double Strength Caramel Color #400 (available from Sethness, Chicago, Ill.) at concentration of 2% by weight in water did not possess any significant flavor. Double strength caramel color is used mainly used for its tinctorial effect. Addition of 2 ppm did not dramatically alter this effect, but it did sweeten the flavor and reduce the burnt nutty nuances of the caramel evident in the water solution. Addition of 1 ppm neotame imparted a definite cocoa note. Addition of 0.5 ppm neotame enhanced the grainy character of the caramel and maintained the cocoa note.

### EXAMPLE 52

Addition of 2 ppm of neotame to an aqueous solution containing 5 ppm of 2,3-dimethyl-pyrazine improved the typically musty cocoa powdery character of the aroma by making it less musty and more cocoa powder-like in both odor and taste. The taste was also improved by the development of darker cocoa powder nuances.

### EXAMPLE 53

At a concentration of 0.3% by weight in water, black strap molasses had a sweet brown sugary character, with a slightly burnt bitter aftertaste. Addition of 0.5 ppm neotame, results in a reduced the burnt bitter and brown aroma and taste which resulted in a more sweet caramellic and fruity aroma and taste. This improvement in flavor was also evident when the neotame concentration was increased to 1.0 and 2.0 ppm, where the top notes become more fruity raisin and prune-like.

### EXAMPLE 54

At 0.2% by weight, 2-fold vanilla extract in fat free milk containing non-fat milk solids, provided a sweet, brown, balsamic and creamy vanilla-like flavor (Control Sample). Addition of neotame at a concentration of 0.5 ppm provided a more intense vanilla flavor with a richer, rounder deeper more resinous beany flavor. Addition of 1.0 ppm neotame, provided a two- to three-fold enhancement in the vanilla flavor. Addition of 2.0 ppm neotame provided a level of vanilla flavor enhancement that was so great, that the vanilla character became very rich and intensely ice cream like, with a slightly cooked caramellic brown cake-like nuance.

Addition of neotame, at a concentration of 1 ppm, to the fat free milk containing non-fat milk solids and 0.1% by weight vanilla extract (half the rate used in the Control Sample) provided a vanilla taste and aroma that was substantially the same as the Control Sample, above, containing 0.2% by weight vanilla extract in the milk. When 0.5 ppm neotame was added to the 0.1% vanilla milk mixture, there was a lowered vanilla impact in both aroma and taste, with the flavor becoming more beany and less resinous and rich, as compared to the Control Sample. When the vanilla concentration was decreased to 0.05% by weight and the neotame concentration was 1.0 ppm, there was a restoration in the vanilla creaminess and resinous character of the milk mixture, comparable to the vanilla flavor of the Control Sample.

### EXAMPLE 55

Sulfurol (4-methyl-5-thiazolylethanol) at a concentration of 25 ppm in water exhibited a vitamin, yeasty and bready character that is characteristic of pot roast or other roasted meats. When evaluated with added neotame, the slight objectionable vitamin odor and taste are reduced and the flavor became more yeasty, bready and brothy in character. This effect was evident in solutions containing 0.5 ppm and 1.0 ppm neotame concentrations. When the neotame concentration was increased to 2.0 ppm, the flavor became very sweet, cakey and bready.

### EXAMPLE 56

Eugenol (4-allyl-2-methoxyphenol) at a concentration of 2.0 ppm in water possessed a characteristically warm and spicy flavor, with a distinctive woody nuance. Addition of neotame at 0.5 ppm or 1.0 ppm, reduced the woody clove, slightly chemical character of eugenol and produced a cleaner, spicy, almost smoky flavor. Addition of 2.0 ppm neotame, provided a clean candy spiciness to the eugenol flavor.

### EXAMPLE 57

Addition of 2.0 ppm neotame, to an aqueous solution of 0.5% ethanol reduced the characteristic harsh chemical aroma and also reduced the flavor of the ethanol.

### EXAMPLE 58

Hexanol (hexyl alcohol) at a concentration of 20 ppm in water provided oily and waxy green in flavor notes, reminiscent of Granny Smith apples. Addition of 0.5 ppm neotame, to a hexanol/water mixture reduces the oily waxy notes and provided a fruitier green apple odor and taste. Addition of 1.0 ppm neotame, increased the fruity flavor notes. Addition of 2.0 ppm neotame provided a rich cooked baked apple fruitiness, with a lingering apple pulp sweetness.

### EXAMPLE 59

Anethole (1-methoxy-4-propenylbenzene) at a concentration of 15 ppm in water had a sweet licorice-like flavor, with a slight phenolic chemical nuance. Addition of neotame at 0.5 ppm and 1.0 ppm, noticeably rounded and intensified the sweetness character of the licorice flavor, and reduced the slight chemical phenolic note. At 1.0 ppm, neotame also provided a lingering anise flavor. At 2.0 ppm, neotame further enhanced the lingering anise flavor and sweet taste.

### EXAMPLE 60

Menthol (isopropyl-4-methylcyclohexan-2-ol) at a concentration of 30 ppm in water possessed a harsh penetrating coolness with a slight spicy chemical Carvacrol-like black cough drop note. Addition of 0.5 ppm neotame brightened the menthol flavor, as the flavor character became cleaner and fresher with a less chemical nuance. The taste also becomes cleaner and rounder, more natural with a clean coolness. With 1.0 ppm added neotame, the solution possessed a clean menthol flavor with a lingering clean freshness. With 2.0 ppm added neotame, the menthol flavor became slightly harsh, with a definite lingering sweetness.

### EXAMPLE 61

α-Terpineol (1-methyl-4-isopropyl-1-cyclohexen-8-ol) is present in most citrus oils and is often used for its rosy floral aroma and flavor. α-Terpineol, at a concentration of 20 ppm in water exhibited a floral, rosy character with citrus waxy nuances. Addition of 0.5 ppm neotame to the terpineol/water mixture reduced the citrus waxy nuances of the aroma and flavor character and enhanced the floral rosy notes. Addition of 1.0 ppm neotame enhanced and better rounded the floral and citrus flavor nuances. At 2.0 ppm, neotame enhanced the fruity blueberry flavor character and imparted a syrupy lingering aftertaste.

### EXAMPLE 62

Use of neotame at concentrations between about 50 ppm and 500 ppm masked the off-notes and enhanced and balanced the menthol-eucalyptus flavor in cough drops.

### EXAMPLE 63

Addition of 0.5 ppm neotame to a 50 ppm solution of acetic acid in water provided a more impacting, less harsh acid flavor, with a quicker perception. At 1.0 ppm, neotame further augmented the acidic perception. When neotame was added at 2.0 ppm to the acetic acid/water solution, the acidic impact was still evident, but there was an additional fruity sweetness evident which tended to tone and round the acidic character and imparted a lingering fruity richness to the aftertaste.

### EXAMPLE 64

Addition of 0.5 ppm neotame to an aqueous solution of butyric acid at a concentration of 50 ppm, diminished the waxy, harsh, acidic flavor nuances of the butyric acid. This effect was also observed when higher concentrations of neotame (1.0 and 2.0 ppm) were evaluated. The butyric acid solution containing 1 ppm neotame was very sweet and had a more pleasant cheesy rich flavor and aroma, with buttery, fruity nuances.

### EXAMPLE 65

2-Methyl-2-pentenoic acid, used to impart a tangy depth to strawberry flavors as well as other fruits flavors, had a unique sharp sweaty acidic impact with fruit body notes when used at a concentration of 20 ppm in water. Addition of neotame at 0.5 ppm, smoothed the sweaty acidic harshness and enhanced the fruitiness of the acid flavor. When added at 1.0 ppm, neotame increased the fruity character of the acid while toning and rounding the acidic impact, making the combined flavor effect more fruity and less acidic tangy. The flavor character of the acid became slightly cooked and jammy, with an acidic nuance, when neotame was added at 2.0 ppm.

### EXAMPLE 66

Orange oil, at a concentration of 50 ppm in water, had a juicy orange aroma and taste profile. Addition of neotame reduced the woody terpenic notes and modified the aroma and taste profile of the oil to provide a fresher juicy orange essence-like character. When the neotame was added at concentrations of 0.5 and 1.0 ppm to the orange oil solution, the taste became more sweet candy orange with a slight marmalade note with no terpenic notes.

### EXAMPLE 67

Addition 0.5 ppm neotame to an aqueous solution of lime oil (50 ppm, distilled West Indian lime oil), enhanced the juicy lime impact of the flavor. At a concentration of 1.0 ppm, neotame provided a nice juicy lime flavor with a pleasant lingering lime depth. When added at 2.0 ppm, neotame provided a lime candy or sorbet/snow cone-like flavor. At all concentrations neotame modified the aroma of the lime oil by enhancing the juicy lime aroma, imparting a slight lemon character and reducing the terpene-like aroma.

### EXAMPLE 68

Beefy-type hydrolyzed vegetable protein at a concentration of 0.4% by weight in water had a roasted and browned meat flavor character. Addition of 0.5 ppm neotame reduced the brown roasted character and enhanced the meaty character of the flavor and provided a longer lasting brothy nuance. Addition of 1.0 ppm neotame made the flavor character meaty brothy and less roasted. The brothy character was quite lingering.

### EXAMPLE 69

Addition of 0.5 ppm neotame to an aqueous solution of salt (sodium chloride, 0.3% by weight) reduced the harshness of the saltiness impact and evened and rounded the saltiness perception.

### EXAMPLE 70

Monosodium glutamate at a concentration of 0.12% by weight in water imparted a salty savory flavor.

Addition of neotame at a concentration of 0.50 ppm reduced the astringency and rounded the savory flavor profile of the MSG. When added at a concentration of 1.0 or 2.0 ppm, neotame imparted sweetness to the MSG as it rounded the salty savory character.

### EXAMPLE 71

Addition of 1 ppm of neotame to a calcium-fortified orange juice modified the flavor such that the juice had enhanced acidity and fresh citrus flavor notes, with no salinity.

### EXAMPLE 72

Addition of 0.25 to 0.5 ppm of neotame to a low sodium chicken soup rounded out the flavor of the product.

### EXAMPLE 73

Addition of 1-2 ppm of neotame to a regular or fat-free prepared whipped topping, a whipped topping prepared from a dry mix or a thawed, frozen whipped topping, provided a topping with improved flavor and sweetness with a quicker and more lasting sweetness and with enhanced dairy and vanilla flavors and reduced artificial vanilla flavor notes. The overall flavor was fuller, more even and less artificial.

### EXAMPLE 74

Addition of 3 ppm of neotame to a saccharin-sweetened cough syrup brightened the flavor of the product, making it sweeter, smoother and easier to swallow.

### EXAMPLE 75

Addition of 3 ppm of neotame to Ceptacol® mouthwash (available from J. B. Williams Co., Inc., Glen Rock, N.J.), sweetened with saccharin, made the product taste sweeter and less chemical.

### EXAMPLE 76

Addition of 4 ppm of neotame to a baking soda toothpaste, evened and rounded the salty taste, reduced bitter flavors and significantly increased the minty aroma and flavor of the toothpaste.

### EXAMPLE 77

Addition of 0.3 to 0.5 ppm of neotame to a fat free fluid milk, fortified with nonfat dry milk solids, reduced the cardboard, oxidized character of the milk, increasing the fresh taste perception.

### EXAMPLE 78

Addition of 1 ppm of neotame to unsweetened West Soy® 100% Organic Non-Dairy Soy Beverage (available from Westbrae Natural Foods, Carson, Calif.), produced a beverage having fresh dairy-like flavor an d eliminated alkaline beany, painty and sour off-tastes.

### EXAMPLE 79

Addition of 1 to 2 ppm of neotame to reconstituted, ready-to-drink vanilla flavored Women's Natural Dietary Supplement Powder® (available from Schiff Products, Inc., Salt Lake City, Utah) dramatically reduced the chalky, cardboard, cereal, bitter and clay-type chemical notes.

### EXAMPLE 80

Addition of 1 to 2 ppm of neotame to vanilla flavored Ensure Plus® nutrition beverage (available from Ross Products, Evansville, Indiana, provided a more creamy, dairy-flavored beverage having enhanced vanilla and caramel flavors. Sour and astringent tastes were eliminated.

### EXAMPLE 81

Addition of 2 ppm of neotame to chocolate flavored Ensure Plus® nutrition beverage, available from Ross Products, rounded the flavor profile of the beverage, enhancing the milky, creamy and dairy notes.

### EXAMPLE 82

Addition of 1 to 2 ppm of neotame to Boost® Vanilla Nutritional Energy Beverage (available from Mead Johnson Nutritionals, Irvine, Calif.) increased the fresh milk, vanilla and caramel flavors and decreased the cardboard, whey notes and throat burn of the beverage.

### EXAMPLE 83

Addition of 2 ppm of neotame to lemon-lime flavored sports drink enhanced the tartness of the beverage, so that the beverage no longer tasted flat. Because of the enhancement in tartness, the saline taste perception was masked. In addition, the lemon-lime aroma was increased.

### EXAMPLE 84

Addition of 1 to 2 ppm of neotame to Crystal Light® Tropical Passions Ready to Drink low calorie soft drink (available from Kraft Foods, Inc., bottled by Cadbury beverages, Stanford, Conn.) increased the aroma of fruit and decreased the throat catch or burn of the benzoate and sorbate preservatives.

### EXAMPLE 85

Addition of 1 to 2 ppm of neotame to Crystal Light® Lemonade, Ready to Drink low calorie soft drink increased the aroma and flavor of lemon and decreased the throat catch or burn of the benzoate and sorbate preservatives.

### EXAMPLE 86

Addition of 1 to 2 ppm of neotame to Crystal Light® Raspberry Ice Ready to Drink low calorie soft drink increased the aroma of fruit and decreased the throat catch or burn of the benzoate and sorbate preservatives.

### EXAMPLE 87

Addition of 1.5 ppm neotame to a sweetened, vanilla-flavored milk product, containing milk (2% fat), 0.25% 2-fold bourbon vanilla and 5% sugar, modified the aroma of the product by reducing the impact and lactic acid sourness of the vanilla flavoring and imparting slight toasted cardboard-like nuances. The neotame-containing product had an enhanced sweet, creamy vanilla/vanillin taste, having a “Dairy Queen” richness and a lingering beany, scalded vanilla, milky aftertaste. The neotame-containing product had enhanced vanilla taste and aroma, and reduced milk sourness present in both the taste and aroma, as compared to the sweetened milk product that did not contain neotame.

Addition of 1.5 ppm neotame the sweetened, vanilla-flavored milk product described above, but containing 0.125% 2-fold bourbon vanilla, provided a sweet, rich creamy and milky aroma, having a beany, vanilla, milk shake-like profile. The aroma impact was slightly lowered and had a slight scalded milk nuance. This product had a slightly lower rich vanilla taste, compared to the product containing 0.25% Bourbon vanilla, but was sweet, creamy, and beany. With the added neotame, this product, containing 0.125% bourbon vanilla, had all of the taste and aroma of the above-described product, containing 0.25% bourbon vanilla and neotame.

### EXAMPLE 88

A chicken soup flavor at a concentration of 3.0 wt. % in warm water, possessed a mild fatty chicken aroma with brothy boiled meaty notes and herbal vegetative, carrot, onion and celery nuances. The solution was salty and tasted of bell pepper and mild fatty chicken meat, with brothy and vegetative notes. Addition of 0.25 ppm neotame to the reconstituted chicken soup intensified the roasted chicken meaty aroma and imparted roasted vegetative nuances. The overall aroma impact, however, was slightly lowered. The taste of the neotame-containing chicken soup was richer and fuller with roasted chicken and vegetative notes and enhanced pan dripping nuances. The saltiness was reduced. The overall organoleptic profile was more balanced.

### EXAMPLE 89

A fish flavor WONF, at a concentration of 0.1 wt. % had a sweet, old shrimp, sushi and tuna like aroma with a sweet ammoniacal note. The aftertaste is bland fishy and slightly salty. Addition of 50 ppb neotame provided a more balanced and fresher fishy impact. There was a pleasant “low tide” seaweed like nuance, which is ammoniacal. The aroma and flavor impact of the fish flavor solution containing 200 ppb neotame was fishy with a fresh green seaweed nuance. The flavor was also better balanced.

### EXAMPLE 90

A garlic & herb flavored tomato sauce had a cooked tomato, spicy, garlic, green herbal aroma with oregano and basil nuances. The taste is sweet tomato, garlic and onion with an herbal after taste. Addition of 50 ppb neotame provided a more blended aroma with a slightly enhanced fresher garlic nuance. The aroma profile was more blended and less green. The flavor of the neotame-containing tomato sauce was better blended with a fresher tomato impression. The aroma of the tomato sauce containing 100 ppb neotame was totally blended with reduced aroma peaks. The herbal and spicy impact was reduced and blended. The flavor sweetness lends to the overall flavor profile. Addition of neotame lent a home cooked, less processed flavor.

### EXAMPLE 91

A processed roasted garlic parmesan sauce had a garlic and roasted cheesy aroma. The flavor is roasted garlic with a creamy cheese body and a peppery after note. The aroma of the sauce containing 300 ppb neotame was milder, less roasted garlic in character with a milder more creamy character. The flavor had lower garlic impact, a creamier Parmesan flavor and a better balanced garlic fleshy nuance.

### EXAMPLE 92

A vegetarian soup concentrate, reconstituted using 1½ teaspoon per 8 oz. water had a sweet cooked celery broth aroma with a green leafy and stalk nuance. The flavor was salty cooked celery, with mixed vegetable juice notes, with no tomato character. The reconstituted soup containing 50 ppb neotame had a celery taste and aroma that was not as cooked. The salty character in the flavor was more blended and the celery taste was better blended. The reconstituted broth, containing 100 ppb neotame, had an aroma that was more blended and mellow. The salty impact was reduced in the flavor profile and the character was richer and slightly sweeter, which improved the soupy character. Addition of 300 ppb neotame, provided the soup with a more blended taste, with sweetness evident in the profile. The sweetness was typically cooked carrot-like in character, which did not greatly detract from the flavor.

### EXAMPLE 93

A processed macaroni and cheese product had an aroma and taste that was very slightly cheesy having a Velveeta-like character with a slight high vegetable protein nuance. Addition of 100 ppm neotame provided only a slight difference in aroma (vs. control). The taste was more intense cheese-like with more intense acidic nuances fewer whey notes.

### EXAMPLE 94

A beef gravy composition, prepared by reconstituting a dry gravy mix had a slightly brothy aroma, with a hydrolyzed vegetable protein and bone character with a peppery spicy and cereal nuance. The aftertaste had buttery, salty and vegetable notes. Addition of 50 ppb neotame to the beef gravy, imparted a more roasted meaty and better blended flavor and aroma. The salty impact and the peppery aftertaste were reduced. Addition of 200 ppb neotame reduced the hydrolyzed vegetable protein character and imparted a more desirable pot roast with rich fatty pan dripping nuances. The spice impact was also reduced.

### EXAMPLE 95

A pork gravy composition, prepared by reconstituting a pork gravy mix using 4.6 oz. per quart of water, had a salty, sweet, spicy, unbalanced hydrolyzed vegetable protein and cereal aroma with slightly buttery creamy nuances. Addition of 50 ppb neotame to the gravy imparted a more balanced hydrolyzed vegetable protein and cereal character with a too sweet fatty pan dripping richness and a lingering spicy peppery aftertaste. The salty impact was reduced.

### EXAMPLE 96

A chicken soup, prepared by reconstituting a chicken soup mix, had a vegetative celery, herbal and brothy aroma. The soup had a chicken brothy taste with spicy salty nuances. Addition of 50 ppb neotame to the reconstituted soup reduced the vegetative, spicy/herbal celery aroma and enhanced the fatty brothy savory chicken nuances. The taste of this neotame-containing soup was a fuller, richer, roasted fatty chicken flavor with more blended vegetable nuances and reduced saltiness. Addition of 0.30 ppm neotame reduced the vegetative/celery aroma character and enhanced the fatty brothy savory chicken nuances. The taste was more balanced with cooked vegetable notes with lower salt harshness and richer roasted chicken and pan dripping nuances.

### EXAMPLE 97

A suspension of standard light yeast (0.3% by weight in water) had a boiled beefy, fatty aroma with slight yeasty savory nuances. The suspension had a weak boiled fatty beef/chicken taste, with slight burnt savory monosodium glutamate notes and herbal and vegetative, with bloody, salty yeast-like nuances. Addition of 50 ppb neotame lowered the aroma impact which had enhanced beefy with reduced fatty notes and lower bloody/savory notes. The neotame lowered the monosodium glutamate savory notes, enhanced the roasted beef, pot roast with gravy-like notes and oven browned vegetable/herbal nuances. Addition of 0.30 ppm neotame imparted a pleasant, more intense roast beef-like aroma character with rich pan drippings nuances. The taste of the 0.30 ppm neotame-containing yeast suspension was slightly sweet, more intense savory, herbal, with decreased salty and monosodium glutamate notes. The characteristic yeast aftertaste was gone. The overall character was more balanced and characteristic of browned pot roast with gravy.

### EXAMPLE 98

A solution of an autolyzed dark yeast extract, 0.35% by weight in water, had a yeasty, slight beefy aroma, with fatty tallow and roasted brothy nuances. This solution had a bloody, beefy and brothy, autolyzed yeast taste, with a slight burnt bitter aftertaste. Addition of 50 ppb neotame imparted an enhanced yeasty aroma, with roasted/boiled brothy and savory nuances. The solution had a more intense roasted beef taste with brothy and savory nuances. Addition of 0.30 ppm neotame imparted a more intense yeasty, roasted beef aroma with fatty and savory nuances. The taste of this solution was more intense, roasted well-done beef with fatty notes and cooked vegetable nuances. The saltiness was reduced.

### EXAMPLE 99

A solution of Gistex (an autolyzed yeast extract), 0.3% by weight in water, had a seared, rare meaty, savory bloody aroma with grilled/roasted beef notes. This solution had a seared roast beef taste, with unbalanced saltiness. There were bitter and vegetative nuances in the aftertaste. Addition of 50 ppb neotame provided a composition was a more roasted beef aroma with rich fatty pan dripping notes. The taste had a balanced flavor profile with stronger roast beef character. The bitterness was gone and the saltiness reduced. Addition of 0.30 ppm neotame, imparted an aroma having fresh roast beef, richer pan dripping notes with a caramelized vegetable and pot roast nuance. The taste had an intensified roast beef character with a fatty browned pot roast nuance.

### EXAMPLE 100

A no sugar added whipped topping was prepared as follows:

| Ingredient | Weight (wt %) | |
|---|---|---|
| Fresh milk¹ | 245.0 | g (83.66%) |
| Neotame | 0.00735 | g (0.0025%) |
| Wiptreme 2320² | 40.0 | g (13.66%) |
| Dariloid QH³ | 4.0 | g (1.366%) |
| Calcium Gluconate⁴ | 3.0 | g (1.02%) |
| Tetrasodium Pyrophosphate⁵ | 0.7 | g (0.24%) |
| Vanillin⁶ | 0.144 | g (0.049%) |

¹Skim or with fat
²Kerry Ingredients, Beloit, Wisconsin
³NutraSweet Kelco Company, San Diego, California
⁴J. T. Baker Chemical Co., Bethlehem, Pennsylvania
⁵Solutia, St. Louis, Missouri
⁶Chart Corp., Paterson, New Jersey

All dry ingredients were combined together in a jar having a screw top lid and mixed thoroughly by shaking or rolling the jar for about 5 minutes. The dry mix was slowly added to the milk, in a mixing bowl, and mixed using a mechanical mixer. Mixing/whipping was continued until the topping formed and held peaks. This dairy topping contained 20% less vanillin compared to a typical whipped topping mix.

### EXAMPLE 101

A no sugar added instant vanilla pudding was prepared as follows:

| Ingredient | Weight (wt %) | |
|---|---|---|
| Fresh milk¹ | 490.0 | g (94.0%) |
| Neotame | 0.0235 | g (0.0045%) |
| Redisol Starch 412² | 16.0 | g (3.07%) |
| Wiptreme 2320³ | 2.0 | g (0.38%) |
| Dariloid QH⁴ | 6.0 | g (1.15%) |
| Calcium Gluconate⁵ | 4.0 | g (0.77%) |
| Tetrasodium Pyrophosphate⁶ | 2.5 | g (0.48%) |
| Salt | 0.29 | g (0.056%) |
| Vanilla Powder #15⁷ | 0.40 | g (0.08%) |
| Yellow #5⁸ | 0.02 | g (0.004%) |
| Yellow #6⁸ | 0.005 | g (0.001%) |

¹Skim or with fat
²A. E. Staley Mfg. Co., Decatur, Illinois
³Kerry Ingredients
⁴NutraSweet Kelco Company, San Diego, California
⁵J. T. Baker Chemical, Co.
⁶Solutia, St. Louis, Missouri
⁷David Michael, Philadelphia, Pennsylvania
⁸Warner Jenkinson, St. Louis, Missouri

The starch was passed through a household sieve into a jar having a screw top lid. The remaining dry ingredients were added to the sieved starch and mixed thoroughly by shaking or rolling the jar for about 5 minutes. The dry mix was slowly added to the milk, in a bowl, using a mechanical mixer, and mixed on a medium speed for about 30 seconds. The resulting vanilla pudding contained 20% less vanilla and 47% less salt compared to a typical sugar-sweetened instant pudding mix.

### EXAMPLE 102

A reconstituted hot cocoa beverage was prepared as follows:

| Ingredient | Weight (wt %) | |
|---|---|---|
| Neotame | 0.002 | g (0.001%) |
| Water | 180.0 | (92.172%) |
| Nonfat Dry Milk¹ | 6.7 | (3.43%) |
| Sweet Dairy Whey¹ | 4.5 | (2.3%) |
| Cocoa Powder, DeZaan D-11-S² | 2.4 | g (1.23%) |
| Wiptreme 2320³ | 1.4 | g (0.72%) |
| Vanillin⁴ | 0.03 | g (0.015%) |
| Carboxymethyl cellulose⁵ | 0.135 | g (0.07%) |
| Flour Salt⁶ | 0.12 | g (0.06%) |

¹Michigan Milk Producers Assn., Novi, Michigan
²Archer Daniels Midland Corp., Decatur, Illinois
³Kerry Ingredients
⁴Chart Corp.
⁵Hercules Food Ingredients, Wilmington, Delaware
⁶Morton, Chicago, Illinois

All dry ingredients were passed through a household sieve into the mixing bowl of a Hobart Mixer and mixed for 5 minutes on the LOW setting. The water was heated to a temperature of about 140° F. The dry mixture was added to the hot water and mixed vigorously until thoroughly dispersed and free of lumps. The hot cocoa mix contained about 6% less cocoa, about 20% less vanillin, and about 40% to about 60% less salt than a typical sugar sweetened hot cocoa mix.

### EXAMPLE 103

A no sugar added chocolate pie filling was prepared as follows:

| Ingredient | Weight (wt %) | |
|---|---|---|
| Fresh milk¹ | 976.0 | g (66.87%) |
| Neotame | 0.1095 | g (0.0075%) |
| Fresh Heavy Cream | 238.0 | g (16.3%) |
| Fresh Whole Eggs | 150.0 | g (10.28%) |
| Corn Starch² | 35.0 | g (2.4%) |
| Unsweetened Chocolate³ | 53.11 | g (3.64%) |
| Salt | 1.67 | g (0.11%) |
| Vanilla Extract, single strength | 5.675 | g (0.39%) |

¹Skim or Whole milk
²Argo, Best Foods, Englewood Cliffs, New Jersey
³Baker's Chocolate, Krafts Foods, White Plains, New York

The milk, cream, eggs, starch and salt were whisked together in a pot suitable for stove top cooking, and heated to boiling, with almost constant whisking. The heat was reduced and the mixture was cooked for one to two minutes. The heated mixture was removed from heat, and neotame, unsweetened chocolate, and vanilla extract were added and whisked until smooth. The resulting pie filling was poured into a baked 8 or 9-inch pie shell and refrigerated for several hours until set. For best flavor, the pie filling recipe, above, contained about 6% less cocoa, about 20% less vanilla extract, and about 40% to about 60% less salt than a typical sugar sweetened chocolate pie filling.

### EXAMPLE 104

An orange juice beverage may be prepared by mixing, for 10 approximately minutes, the following ingredients:

| Ingredient | Amount | |
|---|---|---|
| Minute Maid Premium Orange | 240 | mL |
| Juice Concentrate, Pulp Free | | |
| Filtered Water | 1020 | g |
| Neotame | 3 | ppm |

The beverage, containing 65% orange juice, was then refrigerated and evaluated. Addition of neotame at a concentration of about 3 ppm enhanced the orange/citrus flavor perception providing the orange juice drink with a fresh squeezed flavor and aroma.

### EXAMPLE 105

An orange juice drink, containing 85% orange juice was prepared by mixing, for approximately 10 minutes, the following ingredients:

| Ingredient | Amount | |
|---|---|---|
| Orange Juice Concentrate, Pulp | 302 | mL |
| Free | | |
| Filtered Water | 1020 | g |
| Neotame | 2 | ppm |

The beverage, containing 85% orange juice, was then refrigerated and evaluated. Addition of neotame at a concentration of about 2 ppm enhanced the orange/citrus flavor perception providing the orange juice drink with a fresh squeezed flavor and aroma.

### EXAMPLE 106

A vanilla flavored sweetened milk product, containing 0.5% 2-fold bourbon vanilla extract, sugar (5 wt. %) and 2% fat milk, had a bourbon vanilla, beany aroma with a woody, caramellic, dried fruit body and a creamy powdery nuance. The taste was sweet, bourbon beany vanilla, with smoky, resinous and fruity raisin nuances and a lingering, slightly astringent beany aftertaste. The taste of the basic 2-fold bourbon vanilla extract was somewhat harsh.

Addition of 1.5 ppm neotame provided the milk with a sweet, impacting bourbon vanilla aroma with creamy, rummy and dried fruit nuances. The taste was sweet, smoother and more rounded vanilla, with beany, fruity and spicy tobacco nuances. There was also an evident smoother vanilla/vanilla character with a late burst of sweetness. Neotame greatly enhances the aroma and smooths the flavor, reducing the harshness of the extract. At a concentration 1.5 ppm, neotame is a flavor enhancer, but is too high, since this concentration of neotame also imparts sweetness.

Addition of neohesperidine dihydrochalcone (2 ppm in water) suppressed the vanilla aroma impact and imparted a rich full vanilla aroma with a cooked creamy, rummy, spicy and fruity nuance. The taste was sweet, reduced beany, woody creamy vanilla, with phenolic, smokey and dried fruity, raisin-like notes. The taste of this product had resinous nuances, a lingering sweet creamy licorice aftertaste, with a balanced overall profile.

Addition of talin (2 ppm), provided a product having a week, woody, beany vanilla aroma with resinous, rummy and creamy nuances. The taste of this product had a sweet, bourbon vanilla taste, with a noticeable lingering licorice aftertaste, somewhat reminiscent of a Cream Soda beverage.

Addition of monoammonium glycyrrhizinate (Magnasweet® 100 (available from Mafco Worldwide Corp., Camden, N.J.) washed out the vanilla character of the aroma and imparted cotton candy, vanillin nuances. The bourbon vanilla character of the taste was greatly reduced, having a slight cocoa note. There was a building licorice aftertaste that lingered and drowned out the basic vanilla character. The overall flavor profile is flat.

Both the neohesperidine dihydrochalcone and Magnasweet imparted too much of a licorice aftertaste. Talin, while not distorting the organoleptic profile, weakened and attenuated it.

### EXAMPLE 107

A solution of quinine sulfate (25 ppm in water) had a bitterness of 7. This flavor had a quick onset, with a sharp clean bitterness. Addition of 40 ppm aspartame provided a flavor solution with a bitterness in the range of 6-8. The aspartame imparted a sweet/bitter flavor with a lingering, slightly foreign aftertaste. Aspartame marginally affects bitterness, but it seemed to impart an undesirable organoleptic profile.

Addition of 2 ppm neotame reduced the bitter taste such that the solution had a pleasant bitterness with reduced harshness. The neotame imparted a lightly lingering sweetness to the bitter aftertaste.

### EXAMPLE 108

A coffee beverage, whitened with milk, prepared from fresh brewed Folgers' Regular Coffee, sweetened with an aspartame containing tabletop sweetener, had a weak coffee, instant type aroma with sweet fatty creamy, dairy milky notes with a slight roasted beany nuance. The coffee had a slightly bitter astringent coffee taste, with slight sweet fatty, milky dairy notes with nutty nuances. There was also a slight sweet lingering aftertaste. The overall flavor profile is watery. A whitened coffee beverage, as above, but containing 3 ppm neotame, had a strong coffee aroma with enhanced creamy, milky notes and a fresher coffee impact. The taste of this neotame-containing beverage had lower sweetness with a slightly richer coffee impact than the above-described aspartame-sweetened beverage, but with reduced bitter notes.

Other variations or modifications, which will be obvious to those skilled in the art, are within the scope and teachings of this invention. This invention is not to be limited except as set forth in the following claims.

We claim:

1. A composition comprising N-[N-(3,3-dimethylbutyl)-L-α-aspartyl]-L-phenylalanine 1-methyl ester in a flavor modifying effective amount which does not impart sweetness to the composition.

2. The composition according to claim 1, wherein said composition is a food, flavor, pharmaceutical, nutraceutical, personal care, oral care or household composition.

3. The composition according to claim 2, wherein said food composition is a beverage.

4. The composition according to claim 1, wherein said N-[N-(3,3-dimethylbutyl)-L-α-aspartyl]-L-phenylalanine 1-methyl ester is in an amount of from about 10 ppb to less than about 20 ppm.

5. The composition according to claim 4, wherein said composition is a food composition that comprises a savory or salty ingredient selected from the group comprising sodium chloride, potassium chloride, processed or reaction flavors, hydrolyzed vegetable proteins, monosodium glutamate, ribotides, soy proteins, yeast extracts, autolyzed yeast extracts, meat analogs, cheeses cheese analogs, cheese powders, or mixtures thereof, wherein said N-[N-(3,3-dimethylbutyl)-L-α-asparty]-L-phenylalanine 1-methyl ester is present in an amount sufficient to improve the salty or savory taste of said composition.

6. The composition according to claim 4, wherein said composition is a food composition that comprises a salty ingredient selected from the group comprising sodium chloride, potassium chloride and mixtures thereof, and wherein said N-[N-(3,3-dimethylbutyl)-L-α-aspartyl]-L-phenylalanine 1-methyl ester is present in an amount sufficient to improve a non-salty flavor of said composition.

7. The composition according to claim 4, wherein said N-[N-(3,3-dimethylbutyl)-L-α-aspartyl]-L-phenylalanine 1-methyl ester is present in an amount sufficient to reduce a bitter taste present in said composition.

8. The composition according to claim 4, wherein said composition is a food composition and N-[N-(3,3-dimethylbutyl)-L-α-aspartyl]-L-phenylalanine 1-methyl ester is present in an amount sufficient to enhance an acidic taste present in said composition.

9. The composition according to claim 4, wherein said composition is a food composition and N-[N-(3,3-dimethylbutyl)-L-α-aspartyl]-L-phenylalanine 1-methyl ester is present in an amount sufficient to enhance a mint taste present in said composition.

10. The composition according to claim 4, wherein said composition is a food composition and N-[N-(3,3-dimethylbutyl)-L-α-aspartyl]-L-phenylalanine 1-methyl ester is present in an amount sufficient to enhance a vanilla taste present in said composition.

11. The composition according to claim 4, wherein said composition is a food composition and N-[N-(3,3-dimethylbutyl)-L-α-aspartyl]-L-phenylalanine 1-methyl ester is present in an amount sufficient to enhance a citrus taste present in said composition.

12. The composition according to claim 4, wherein said composition is a beverage and N-[N-(3,3-dimethylbutyl)-L-α-aspartyl]-L-phenylalanine 1-methyl ester is present in an amount sufficient to enhance an acidic taste present in said composition.

13. A composition comprising an aroma modifying effective amount of N-[N-(3,3-dimethylbutyl)-L-α-aspartyl]-L-phenylalanine 1-methyl ester.

14. The composition according to claim 13, said composition is an ingestible composition, wherein said N-[N-(3,3-dimethylbutyl)-L-α-aspartyl]-L-phenylalanine 1-methyl ester is present in an amount of from about 10 ppb to about 20 ppm.

15. The composition according to claim 13, said composition is a composition not intended for ingestion, wherein said N-[N-(3,3-dimethylbutyl)-L-α-aspartyl]-L-phenylalanine 1-methyl ester is present in an amount of from about 10 ppb to about 1800 ppm.

16. A composition comprising N-[N-(3,3-dimethylbutyl)-L-α-aspartyl]-L-phenylalanine 1-methyl ester and one or more flavor ingredients, wherein said N-[N-(3,3-dimethylbutyl)-L-α-aspartyl]-L-phenylalanine 1-methyl ester is present in an amount effective to modify a taste or aroma of said flavor ingredient.

17. The composition according to claim 16, wherein said N-[N-(3,3-dimethylbutyl)-L-α-aspartyl]-L-phenylalanine 1-methyl ester is present in an amount of from about 10 ppb to about 20 ppm.

18. The composition according to claim 16, wherein said N-[N-(3,3-dimethylbutyl)-L-α-aspartyl]-L-phenylalanine 1-methyl ester is present in an amount of from about 10 ppb to about 1800 ppm.

19. The composition according to claim 16, wherein said flavoring ingredient comprises an acetylene, alcohol, aldehyde, amine, carboxylic acid, ester, lactone, ether, acetal, heterocycle, hydrocarbon, ketone, sulfur-containing ingredient, essential oil, oleoresin, tincture, extract, botanical, process flavor, or a mixture thereof.

20. The composition according to claim 16, wherein said flavoring ingredient provides a balsamic, chemical, medicinal, citrus, terpenic, ethereal, fatty, rancid, waxy, soapy, dairy, floral, sweet, fruity, green, grassy, mossy, minty, camphoraceous, meaty, brothy, animalic, hydrolyzed vegetable protein, vegetable, soupy, roasty, burnt, coffee, nutty, spicy, herbaceous, sulfurous, alliaceous, wine-like, woody, or smoky taste or aroma.

21. The composition according to claim 16, wherein said flavoring ingredient provides an anise, balsam, caramel, chocolate, cinnamon, honey, sweet, vanilla, lemon, lime, orange, butter, cheese, creamy, milky, oily, sour, garlic or onion taste or aroma.

22. The composition according to claim 16, wherein, said flavoring ingredient is selected from the group comprising: black strap molasses, licorice, kola nut, foenugreek, lemon oil, lime oil, orange oil, mint, vanilla, cassia oil, ginger oil, nutmeg oil, eugenol, hexanol, anethole, menthol, alpha-terpineol, sulfurol, cis-hexenol, phenyl ethyl alcohol, hexanal, decanal, trans-2-hexenal, benzaldehyde, cinnamic aldehyde, citral, acetic acid, butyric acid, 2-methyl-2-pentenoic acid, ethyl butyrate, isoamyl acetate, methyl anthranilate, ethyl maltol, methyl amyl ketone, 2,3-butanedione, 4-(2,6,6-trimethyl-2-cyclohexen-1-yl)-3-buten-2-one, 4-p-methoxyphenyl-2-butanone, 4-hydroxy-octanoic acid-gamma-lactone, 5-hydroxy-decanoic acid-delta-lactone, 5-hydroxy-dodecanoic acid-delta-lactone, 5-hydroxy-tetra-decanoic acid-delta-lactone, 2,3-dimethylpyrazine, quinine sulfate, 3-hydroxy-2-methyl-gamma pyrone, caramel color, hydrolyzed vegetable protein, yeast and autolyzed yeast extract.

23. A method for modifying a flavor of a composition, comprising adding N-[N-(3,3-dimethylbutyl)-L-α-aspartyl]-L-phenylalanine 1-methyl ester to said composition in an amount of from about 10 ppb to about 1800 ppm, wherein said flavor is a flavor other than that provided by said N-[N-(3,3-dimethylbutyl)-L-α-aspartyl]-L-phenylalanine 1-methyl ester.

24. The method according to claim 23, wherein said composition is a food, flavor, pharmaceutical, nutraceutical, personal care, oral care or household composition.

25. The method according to claim 23, wherein said composition is a food composition and said method comprises improving a salty taste of the composition, wherein N-[N-(3,3-dimethylbutyl)-L-α-aspartyl]-L-phenylalanine 1-methyl ester is added in an amount of from about 25 ppb to about 600 ppm.

26. The method according to claim 23, wherein said composition is a salt-containing food composition and said method comprises improving a non-salty taste of the composition, wherein N-[N-(3,3-dimethylbutyl)-L-α-aspartyl]-L-phenylalanine 1-methyl ester is added in an amount of from about 25 ppb to about 600 ppm.

27. The method according to claim 23, comprising reducing a bitter taste of the composition, wherein N-[N-(3,3-dimethylbutyl)-L-α-aspartyl]-L-phenylalanine 1-methyl ester is added in an amount of from about 25 ppb to about 600 ppm.

28. The method according to claim 23, wherein said composition is a food composition and said method comprises enhancing the tartness or an acidic taste of the composition, wherein N-[N-(3,3-dimethylbutyl)-L-α-aspartyl]-L-phenylalanine 1-methyl ester is added in an amount of from about 25 ppb to about 600 ppm.

29. The method according to claim 23, wherein said composition is a beverage and said method comprises enhancing the tartness or an acidic taste of the beverage, wherein N-[N-(3,3-dimethylbutyl)-L-α-aspartyl]-L-phenylalanine 1-methyl ester is added in an amount of from about 10 ppb to about 100 ppm.

30. The method according to claim 23, wherein said composition is a food composition and said method comprises enhancing a citrus flavor of the composition, wherein N-[N-(3,3-dimethylbutyl)-L-α-aspartyl]-L-phenylalanine 1-methyl ester is added in an amount of from about 25 ppb to about 600 ppm.

31. The method according to claim 23, wherein said composition is a food composition and said method comprises enhancing a mint flavor of the composition, wherein N-[N-(3,3-dimethylbutyl)-L-α-aspartyl]-L-phenylalanine 1-methyl ester is added in an amount of from about 25 ppb to about 600 ppm.

32. The method according to claim 23, wherein said mint flavor is a peppermint, spearmint, or wintergreen flavor.

33. The method according to claim 23, wherein said composition is a food composition and said method comprises enhancing a spearmint flavor of the composition, wherein N-[N-(3,3-dimethylbutyl)-L-α-aspartyl]-L-phenylalanine 1-methyl ester is added in an amount of from about 25 ppb to about 600 ppm.

34. The method according to claim 23, wherein said composition is a food composition and said method comprises enhancing a peppermint flavor of the composition, wherein N-[N-(3,3-dimethylbutyl)-L-α-aspartyl]-L-phenylalanine 1-methyl ester is added in an amount of from about 25 ppb to about 600 ppm.

35. The method according to claim 23, wherein said composition is a food composition and said method comprises enhancing a ginger flavor of the composition, wherein N-[N-(3,3-dimethylbutyl)-L-α-aspartyl]-L-phenylalanine 1-methyl ester is added in an amount of from about 25 ppb to about 600 ppm.

36. The method according to claim 23, wherein said composition is a food composition and said method comprises enhancing a cocoa flavor of the composition, wherein N-[N-(3,3-dimethylbutyl)-L-α-aspartyl]-L-phenylalanine 1-methyl ester is added in an amount of about 25 ppb to about 600 ppm.

37. The method according to claim 23, wherein said composition is a food composition and said method comprises enhancing a vanilla flavor of the composition, wherein N-[N-(3,3-dimethylbutyl)-L-α-aspartyl]-L-phenylalanine 1-methyl ester is added in an amount of from about 25 ppb to about 600 ppm.

38. The method according to claim 23, wherein said composition is a food composition and said method comprises improving a savory taste of the composition, wherein N-[N-(3,3-dimethylbutyl)-L-α-aspartyl]-L-phenylalanine 1-methyl ester is added in an amount of from about 25 ppb to about 600 ppm.

39. The method according to claims 23, wherein said N-[N-(3,3-dimethylbutyl)-L-α-aspartyl]-L-phenylalanine 1-methyl ester is present in an amount which does not impart sweetness to said composition.

40. A method for enhancing the aroma of food compositions comprising adding an aroma-enhancing amount of N-[N-(3,3-dimethylbutyl)-L-α-aspartyl]-L-phenylalanine 1-methyl ester.

41. The method according to claim 40, wherein the N-[N-(3,3-dimethylbutyl)-L-α-aspartyl]-L-phenylalanine 1-methyl ester is added in an amount of from about 25 ppb to about 600 ppm.

42. A method for producing a food composition, wherein said food composition includes an acid and N-[N-(3,3-dimethylbutyl)-L-α-aspartyl]-L-phenylalanine 1-methyl ester, the improvement which comprises reducing the amount of acid in the composition by about 15% to about 25% by weight when said N-[N-(3,3-dimethylbutyl)-L-α-aspartyl]-L-phenylalanine 1-methyl ester is present in the composition in an amount of from about 10 ppb to about 100 ppm.

43. A method for producing a beverage, wherein said beverage includes an acid and N-[N-(3,3-dimethylbutyl)-L-α-aspartyl]-L-phenylalanine 1-methyl ester, the improvement which comprises reducing the amount of acid in the beverage by about 15% to about 25% by weight when said N-[N-(3,3-dimethylbutyl)-L-α-aspartyl]-L-phenylalanine 1-methyl ester is present in the beverage in an amount of from about 10 ppb to about 100 ppm.

44. The method according to claims 42 or 43, wherein the acid is selected from the group comprising citric acid, acetic acid, phosphoric acid, tartaric acid, malic acid, fumaric acid, lactic acid and adipic acid.

45. The method according to claims 42 or 43, wherein the beverage includes L-α-aspartyl-L-phenylalanine 1-methyl ester as a sweetening agent.

46. A method for producing a flavored composition, wherein said composition includes a flavoring ingredient and N-[N-(3,3-dimethylbutyl)-L-α-aspartyl]-L-phenylalanine 1-methyl ester, the improvement comprising reducing the amount of flavoring ingredient present in said composition by about 10% to about 60% by weight when said N-[N-(3,3-dimethylbutyl)-L-α-aspartyl]-L-phenylalanine 1-methyl ester is present in the composition in an amount of from about 10 ppb to about 1000 ppm.

47. The method according to claim 46, wherein the flavoring ingredient is selected from the group comprising an acetylene, alcohol, aldehyde, amine, carboxylic acid, ester, lactone, ether, acetal, heterocycle, hydrocarbon, ketone, sulfur-containing ingredient, essential oil, oleoresin, tincture, extract, botanical, process flavor, or a mixture thereof.

48. A method for enhancing a taste of a composition, the improvement comprising adding N-[N-(3,3-dimethylbutyl)-L-α-aspartyl]-L-phenylalanine 1-methyl ester to said composition in an amount of from about 10 ppb to about 1000 ppm, wherein said taste is a taste other than that provided by said N-[N-(3,3-dimethylbutyl)-L-α-aspartyl]-L-phenylalanine 1-methyl ester.

49. A tabletop salt substitute comprising sodium chloride and about 0.1 ppm to about 1.0 ppm N-[N-(3,3-dimethylbutyl)-L-α-aspartyl]-L-phenylalanine 1-methyl ester.

50. A method of enhancing a flavor of an orange juice drink comprising including about 100 ppb to about 15 ppm N-[N-(3,3-dimethylbutyl)-L-α-aspartyl]-L-phenylalanine 1-methyl ester in said orange juice drink.

51. A food composition comprising an acid and N-[N-(3,3-dimethylbutyl)-L-α-aspartyl]-L-phenylalanine 1-methyl ester, wherein the composition contains about 20% less acid when said N-[N-(3,3-dimethylbutyl)-L-α-aspartyl]-L-phenylalanine 1-methyl ester is present in the composition in an amount of from about 10 ppb to about 100 ppm.

52. A beverage comprising an acid and N-[N-(3,3-dimethylbutyl)-L-α-aspartyl]-L-phenylalanine 1-methyl ester, wherein the beverage contains about 20% less acid when said N-[N-(3,3-dimethylbutyl)-L-α-aspartyl]-L-phenylalanine 1-methyl ester is present in the beverage in an amount of from about 10 ppb to about 100 ppm.

53. A food composition selected from the group comprising a syrup, sauce, salad dressing, lite salad dressing, pudding, sugar-free pudding, gravy, soup, beverages, tea, coffee, whitened coffee, carbonated beverages, juice, fruit-flavored drink, milk, fat-free milk, milk beverage, soy beverage, flavored dietary supplement beverage, nutrition beverage, sports drink, soft drink, hot cocoa beverage, filling, frostings, cheese cake filling, whipped topping, pie filling, sugar-free pie filling, pie crust, confectionery, macaroni and cheese product, meat product, vegetable product, soy-containing product, and cocoa- or chocolate-containing product, wherein said composition contains N-[N-(3,3-dimethylbutyl)-L-α-aspartyl]-L-phenylalanine 1-methyl ester in an amount sufficient to improve a flavor characteristic of said composition, without imparting sweetness to said composition.

54. A composition selected from the group comprising an oral care product, mouthwash, cough syrup, toothpaste, flavoring composition, cough drop, chewable tablet, food supplement, herbal remedy, plant extract, wherein said composition contains N-[N-(3,3-dimethylbutyl)-L-α-aspartyl]-L-phenylalanine 1-methyl ester in an amount sufficient to improve a flavor characteristic of said composition, without imparting sweetness to said composition.

55. A composition selected from the group comprising a perfume, pet product, air freshener, cleaning product, paste, cream, and ointment, wherein said composition contains N-[N-(3,3-dimethylbutyl)-L-α-aspartyl]-L-phenylalanine 1-methyl ester in an amount sufficient to improve an aroma characteristic of said composition.
